(19) United States
(12) Patent Application Publication
(10) Pub. No.: US 2026/0184604 A1
(43) Pub. Date: Jul. 2, 2026

(54) REMOVAL OF METAL SPECIES

(71) Applicant: Seloxium Limited, Oxford (GB)

(72) Inventors: Kane Hands, Oxford (GB); Steve Colley, Oxford (GB); Nick Hankins, Oxford (GB)

(73) Assignee: Seloxium Limited, Oxford (GB)

(21) Appl. No.: 19/549,871

(22) Filed: Feb. 25, 2026

Related U.S. Application Data
(63) Continuation of application No. PCT/GB24/52202, filed on Aug. 22, 2024.

(30) Foreign Application Priority Data
Aug. 25, 2023 (GB) 2312998.4

(51) Int. Cl. C02F 1/28; C02F 1/52; C02F 101/20

(52) U.S. Cl. CPC C02F 1/285; C02F 1/52; C02F 2101/20; C02F 2305/00

(57) ABSTRACT

The present disclosure relates to a process for removing a metal species from a solution, for instance a metallic cation, the solution comprising the metal species and a solvent. The process comprises treating the solution with a polymer comprising ionisable groups, and a ligand to form a complex, and treating the solution with a precipitant.

### CROSS-REFERENCE TO RELATED APPLICATIONS

The present application is a continuation of International Application PCT/GB2024/052202, designating the United States, filed on Aug. 22, 2024, and claiming priority to GB application 2312998.4, filed on Aug. 25, 2023; each of which is incorporated by reference herein, in its entirety, for all purposes.

### FIELD

The present disclosure relates to a process for removing a metal species from a solution, for instance a metallic cation, the solution comprising the metal species and a solvent.

### BACKGROUND

There are currently a number of known processes for the removal of charged species from liquid-phase effluents, including processes for the removal of charged metal species. Examples of effluent that typically contain charged species requiring removal, or whose removal would be beneficial both economically, environmentally, and (by extension) socially, are effluents in the metal finishing industry, the mining and mineral processing industries, the textile and battery industries, the catalyst manufacturing industry, and effluents arising from soil washing of heavy metal contaminated land and pharmaceutical processes in which metal catalysts are used. Metal ions are widely used in industrial processes, and such use means that they are present in the associated effluent streams.

As noted above, there are economic and environmental incentives for removing metal ions from liquid-phase effluents. Environmental incentives arise from the increasing stringency of discharge regulations. Metal ions are not biodegradable and can bio accumulate in the human body as well as in the bodies of other animals, leading to potentially deleterious effects on health. Economic incentives arise from the market value of specific metal species, platinum group metals (PGMs), and gold can, for instance, have a market value of approximately £30/g to £50/g. Thus, it is worth recovering such metals from effluents provided a cost-effective and efficient method is available.

Removal and recovery of such metal species, particularly platinum group species, gold and silver, is further beneficial from a sustainability perspective. Industrial processes can be carried out on a large scale and thus generate a significant level of waste. When such waste includes precious metals, for example from the use of catalysts in the industrial process, it is both economic and environmentally desirable for the precious metal species to be recovered in bulk and ideally, recycled. Industrial processes use a variety of precious metal-bearing catalysts in the manufacture of drugs and other products. For example, palladium is widely used to facilitate cross-couplings, rhodium is used in hydroformylation reactions, and platinum is used to perform asymmetric hydrogenations.

Known metal ion removal techniques have their advantages and limitations in various applications. A commonly used method is ion exchange. Ion exchange is effective to remove small amounts of high concentration metal-ion contaminated water, but the cost and secondary pollution when regenerating resin are critical. Furthermore, the required solid-liquid, fixed-bed operation is complex, and the solid-liquid fixed bed operation is not effective in a single pass due to inherent mass transfer limitations between phases. Ion exchange resins are not therefore economical to rapidly treat high volumes of metal-ion wastewater. Electrochemical techniques are regarded as a rapid and well-controlled method to remove metals with fewer chemical additions and less sludge production. The drawbacks are high capital and running costs, limited selectivity and complexity of operation. Adsorption is an alternative method but the processes suffer from similar drawbacks to ion exchange and the balance between cost and effectiveness of physico-chemical adsorbents is difficult. Bio sorption has proven a promising sustainable removal method. The advantages are high overflow rate and low production volumes of concentrated sludge. The capital, maintenance and operational cost, are, however, high. The sludge produced by the bio sorption coagulation-flocculation method has good settling and dewatering properties, but the amount of chemical dosage, lack of selectivity and the sludge treatment/disposal are the main disadvantages to overcome. Finally, membrane filtration technology is a selective removal method based on size of species, but high cost, membrane fouling and low permeate flux are the limitations.

Processes for removal of metal ions are disclosed in, for example, Hankins et al., Separation and Purification Technology, 2006, 51 (1), 48-56; WO 2016/079511; Shen et al., Separation and Purification Technology, 2015, 152, 101-107; Shen et al., Separation and Purification Technology, 2016, 159, 169-176; Shen et al., Emerging Membrane Technology for Sustainable Water Treatment, 2016, 249; Shen et al., Desalination, 2017, 406, 109-118; and Shen et al., Desalination, 2017, 406, 67-73. Such processes use polymers to remove charged species from solution, including the use of polymer-surfactant aggregates to avoid sludge production and provide an environmentally friendly way to remove charged species.

There was, however, room for improvement with the above processes, particularly in the area of selectively removing a particular ion from a mixture of ions in solution. Selective removal is difficult, especially when removing a metal ion from a mixture of other metal ions of the same number and/or type of charges. Resin-based ion exchange technologies have previously been employed, such as in Colley et al., 2014, 32, 5, but they have drawbacks as noted above. Performance of resin-based ion exchange technology is also limited by a relatively slow kinetic and hydraulic performance due to the heterogeneous solid-liquid interactions that are required for its operation, and by the corresponding complexity of fixed-bed process operation.

An economical and sustainable technology, which increases the treatment speed and/or selective removal compared to ion exchange resins, is provided by WO 2021/053326. WO 2021/053326 provides a process to selectively remove charged species from industrial process and effluent streams. The process employs a polymer which is chemically modified via functionalisation, i.e. covalent bonding, to allow selective removal of the target ion. In using a functionalised polymer, the process of WO 2021/053326 has the potential to require further synthesis steps and the consequences thereof compared to the process of the present disclosure.

There is still therefore a need for a process to effectively remove and recover metal species from aqueous waste solutions, such as from industrial pharmaceutical process waste streams. In particular, there is a need to efficiently and economically remove multiple metal species from a single solution and a need to remove metal species at high concentrations and high solvent volumes. Such removal of multiple species and/or high metal concentrations and solvent volumes is difficult, especially when a commercially viable process is required. Handling high metal concentrations and high volumes of solvent over an extended period of time (i.e. high throughput) can lead to a short lifetime of the treatment apparatus. As noted above, ion exchange resins suffer from slow kinetic and hydraulic performance meaning their use industrial applications has limitations with respect to concentrations and contaminants.

The present disclosure seeks to address these needs with the various aspects and embodiments defined herein.

### SUMMARY

The inventors have developed a simple, low cost process using inexpensive, easily manufactured and recyclable materials to recover metal species, particularly precious metal species, from industrial process and effluent streams including pharmaceutical waste streams. The process is not complex and is sustainable. It generally uses materials available in bulk at low cost such as polymers, ligands, and precipitants. The polymer employed in the present process comprises ionisable groups that associate, preferably electrostatically, with corresponding or mirror groups on the ligand. Specifically, the polymer comprises acidic/basic groups which associate with opposite or mirror groups on the ligand, the ligand including one or more group that binds the metal species. The process further includes a precipitant with a hydrophobic moiety and at least one group that binds the metal species and/or the polymer. A complex is formed by the polymer, ligand and metal species. The complex further interacts with the precipitant and the complex (polymer-ligand-metal) and precipitant (e.g. surfactant or polymer with ionisable groups) may be described as an aggregate. The aggregate is self-flocculating and can easily be removed prior to facile recovery of the target metal species. The removal agents can also be recycled, reducing both cost and environmental impact.

The formation of the polymer-ligand salt and its complex with the metal species in the present disclosure is different from the functionalised polymer in e.g. WO 2021/053326. The polymer and ligand in the present disclosure are separate chemical entities (not a functionalised polymer) and interact with each other via electrostatic or physical forces. The formation of a polymer-ligand salt and complex has been found to be particularly beneficial in terms of the ease of production allowing for faster process scale-up at lower cost. In addition, there is greater flexibility and a reduction in waste generation and energy requirements. Specifically, the polymer/ligand mixture is more versatile during production because there is no covalently bonded functional group to take into consideration. This provides a significant commercial benefit as it allows for adjustment of the polymer-ligand ratio whilst processing to achieve optimal recoveries in spite of batch variation.

Accordingly, a first aspect of the present disclosure provides a process for removing a metal species from a solution, wherein the solution comprises a metal species and a solvent, which process comprises treating the solution with a polymer comprising ionisable groups and a ligand, to form a complex; and treating the solution with a precipitant; wherein the ionisable groups of the polymer are basic and the ligand comprises at least one acidic group, or wherein the ionisable groups of the polymer are acidic and the ligand comprises at least one basic group; wherein the ligand comprises at least one group that binds the metal species; and wherein the precipitant comprises at least one group that binds the metal species and/or the polymer, and at least one hydrophobic moiety.

A second aspect of the present disclosure provides use of a polymer comprising ionisable groups, a ligand, and a precipitant, to remove a metal species from a solution, wherein the solution comprises the metal species and a solvent; wherein the ionisable groups of the polymer are basic and the ligand comprises at least one acidic group, or wherein the ionisable groups of the polymer are acidic and the ligand comprises at least one basic group; wherein the ligand comprises at least one group that binds the metal species; and wherein the precipitant comprises at least one group that binds the metal species and/or the polymer and further comprises at least one hydrophobic moiety.

A third aspect of the present disclosure provides use of a salt to remove a metal species from a solution, wherein the solution comprises the metal species and a solvent, wherein the salt comprises:
(a) a cation of a polymer comprising basic ionisable groups and an anion of a ligand comprising at least one acidic group; or
(b) an anion of a polymer comprising acidic ionisable groups and a cation of a ligand comprising at least one basic group;
wherein the ligand comprises at least one group capable of binding a metal species.

A fourth aspect of the present disclosure provides a salt comprising a cation of a polymer comprising basic ionisable groups and an anion of a ligand; wherein the basic ionisable groups of the polymer are N-containing groups, preferably amine groups; and wherein the ligand comprises a C₁-C₁₂ alkyl and: (i) at least one carboxyl group, sulfonic acid or phosphonate group, and (ii) at least one thiol, thioether, thioester, thioamide, dithiocarbamate, thionyl, amine, or a combination thereof; or wherein the ligand comprises a N-heterocycle containing 1 to 5 carbon atoms, and at least one thiol, thioether, thioester, thioamide, dithiocarbamate, thionyl, alcohol, ether, ester, ketone, carboxylic acid, or a combination thereof.

A fifth aspect of the present disclosure provides a salt comprising an anion of a polymer comprising acidic ionisable groups and a cation of a ligand; wherein the acidic ionisable groups of the polymer are carboxyl groups or sulfonic acid groups; and wherein the ligand comprises a C₁-C₁₂ alkyl and: (i) at least one N-containing group, and (ii) at least one thiol, thioether, thioester, thioamide, amine, phosphonic acid group, or a combination thereof; or wherein the ligand comprises a N-heterocycle containing 1 to 5 carbon atoms, and at least one thiol, thioether, thioester, thioamide, dithiocarbamate, thionyl, alcohol, ether, ester, ketone, carboxylic acid, or a combination thereof.

A sixth aspect of the present disclosure provides a composition comprising the salt as defined herein.

A seventh aspect of the present disclosure is a product comprising (a) a complex comprising: (i) a cation of a polymer comprising basic ionisable groups and an anion of a ligand comprising at least one acidic group; or an anion of a polymer comprising acidic ionisable groups and a cation of a ligand comprising at least one basic group; and (ii) a metal species; and (b) a precipitant, wherein the ligand comprises at least one group capable of binding a metal species and the metal species is bound to said at least one group; and wherein the precipitant comprises at least one group that is bound to the metal species and/or the polymer and further comprises at least one hydrophobic moiety.

These aspects and embodiments thereof are set out in the appended independent and dependent claims. It will be appreciated that features of the dependent claims may be combined with each other and with features of the independent claims in combinations other than those explicitly set out in the claims. Furthermore, the approaches described herein are not restricted to specific embodiments such as those set out below, but include and contemplate any combinations of features presented herein. In this respect, the disclosure is intended to be read holistically, such that any separate features or elements in any of the various aspects and embodiments should be viewed as combinable unless the context clearly dictates otherwise.

### BRIEF DESCRIPTION OF THE DRAWINGS

FIG. 1: FIG. 1 is a key for understanding the remaining figures.

FIG. 2: FIG. 2 is a schematic representation of a polymer with ionisable groups.

FIG. 3: FIG. 3 is a schematic representation of a salt formed between the polymer with ionisable groups and the ligand.

FIG. 4: FIG. 4 is a schematic representation of a complex formed between the polymer with ionisable groups, the ligand, and the metal species in solution.

FIG. 5: FIG. 5 is a schematic representation of an aggregate formed between the polymer with ionisable groups, the ligand, and the metal species in solution, and a precipitant. The aggregate depicted is expected to be a reasonable representation of the obtained flocculated product.

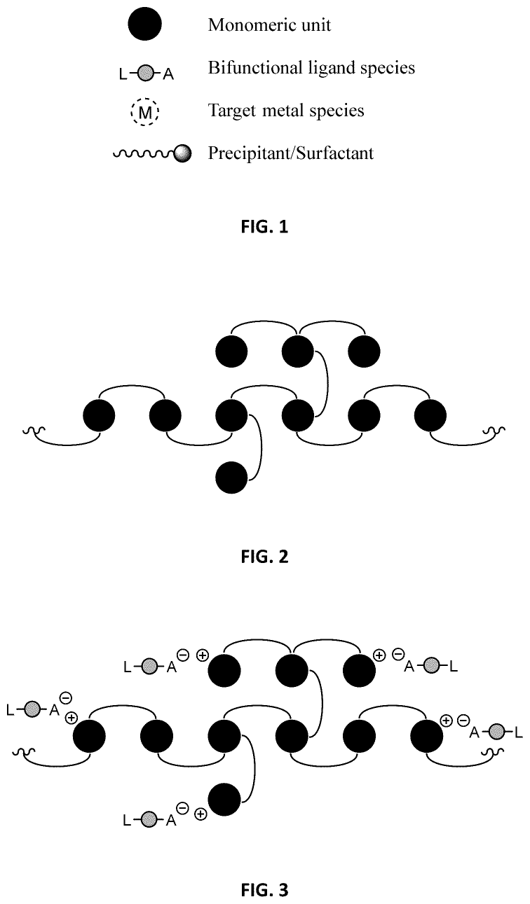

The drawings are exemplary only and should not be construed as limiting the disclosure.

### DETAILED DESCRIPTION

While various exemplary embodiments are described or suggested herein, other exemplary embodiments utilizing a variety of methods and materials similar or equivalent to those described or suggested herein are encompassed by the general inventive concepts. Those aspects and features of embodiments that are implemented conventionally may not be discussed or described in detail in the interests of brevity. It will thus be appreciated that aspects and features of apparatus and methods described herein which are not described in detail may be implemented in accordance with any conventional techniques for implementing such aspects and features.

As used in this specification and the claims, the singular forms “a,” “an,” and “the” include plural referents unless the context clearly dictates otherwise. Unless otherwise stated, the term “about” modifying the quantity of a component refers to variation in the numerical quantity that can occur, for example, through typical measuring and handling procedures used for making concentrates, mixtures or solutions in the real world; through inadvertent error in these procedures; through differences in the manufacture, source, or purity of the materials employed, or to carry out the methods; and the like. The term “about” also encompasses amounts that differ due to different equilibrium conditions for a composition resulting from a particular initial mixture. Whether or not modified by the term “about”, the claims include equivalents to the quantities. As used herein, the term “at least” includes the end value of the range that is specified. For example, “at least 50 wt %” includes the value 50 wt %.

The ranges provided herein provide exemplary amounts of each of the components. Each of these ranges may be taken alone or combined with one or more other component ranges.

As used herein, wt % means “weight percentage” as the basis for calculating a percentage. Unless otherwise indicated, all wt % values are on an actives basis. Unless otherwise indicated, all % values are calculated on a weight basis, and are provided with reference to the total weight of the product in which the substance is present.

As used herein, “substantially free” means no more than trace amounts, i.e. the amount of the substance(s) concerned is negligible. In various embodiments, “substantially free” means no more than 1000 ppm, preferably no more than 100 ppm, more preferably no more than 10 ppm, even more preferably no more than 1 ppm of the substance(s) concerned.

In all aspects of the present disclosure, the disclosure includes, where appropriate, all enantiomers and tautomers of the compounds disclosed herein. A person skilled in the art will recognise compounds that possess optical properties (one or more chiral carbon atoms) or tautomeric characteristics. The corresponding enantiomers and/or tautomers may be isolated/prepared by methods known in the art.

Some of the compounds disclosed herein may exist as stereoisomers and/or geometric isomers—e.g. they may possess one or more asymmetric and/or geometric centres and so may exist in two or more stereoisomeric and/or geometric forms. The present disclosure contemplates the use of all the individual stereoisomers and geometric isomers of those compounds, and mixtures thereof. The terms used in the claims encompass these forms.

As used herein, an alkyl group can be a substituted or unsubstituted, linear or branched chain saturated radical. The alkyl group may, for instance be a C₁-C₃₅ alkyl group, which is an alkyl group having 1 to 35 carbon atoms, a C₁-C₃₀ alkyl group, which is an alkyl group having 1 to 30 carbon atoms, or a C₁-C₂₀ alkyl group, which is an alkyl group having 1 to 20 carbon atoms. Examples of alkyl groups having 1 to 20 carbon atoms include methyl, ethyl, propyl, butyl, pentyl, hexyl, heptyl, octyl, nonyl, decyl, dodecyl, hexadecyl, heptadecyl, octadecyl, nondecyl, eicosyl, and isomeric forms thereof. Cycloalkyl groups are derived from cycloalkanes by removal of a hydrogen atom from a ring carbon atom; they include cyclopropyl, cyclobutyl, cyclopentyl, cyclohexyl, cycloheptyl, cyclooctyl, 2-methylcyclopentyl, 2,3-dimethyl-cyclobutyl, 4-methylcyclobutyl, 3-cyclopentylpropyl, and the like.

As used herein, an alkenyl group can be a substituted or unsubstituted, linear, branched or cyclic unsaturated radical. An alkenyl group thus contains one or more carbon-carbon double bonds and may, for instance, be a C₂-C₃₀ alkenyl group. Examples of alkenyl groups having 2 to 20 carbon atoms include ethenyl, propenyl, butenyl, pentenyl, hexenyl, heptenyl, octenyl, nonenyl, decenyl, dodecenyl, hexadecenyl, heptadecenyl, octadecenyl, nondecenyl, eicosenyl, and isomeric forms thereof. Cycloalkenyl groups include cyclobutenyl, cyclopentenyl, cyclohexenyl, cycloheptenyl, cyclooctenyl, and the like, and isomeric forms thereof.

As used herein, an aromatic or aryl group is a substituted or unsubstituted group derived from arenes by removal of a hydrogen atom from a ring carbon atom. This group includes unsubstituted or substituted heteroaryls. Aryl groups include phenyl, tolyl, xylyl, naphthyl, biphenylyl, and the like, and heteroaryls include pyrrolyl, furanyl, thienyl, oxazolyl, isoxazolyl, thiazolyl, imidazolyl, triazolyl, tetrazolyl, pyridinyl, pyrimidyl, pyrazinyl, pyridazinyl, indolyl, benzofuranyl, benzothiophenyl, thiophenyl, benzimidazolyl, quinolinyl, isoquinolinyl, quinazolinyl, quinoxalinnyl, pyrazolyl, and the like.

When substituted, the above groups may include one or more substituents selected from alkyl, aryl, cyano, amino, alkylamino, arylamino, diarylamino, arylalkylamino, amido, acylamido, hydroxyl, oxo, halo, carboxy, ester, acyl, acyloxy, alkoxy, aryloxy, haloalkyl, sulfonic acid, sulfhydryl (i.e. thiol), alkylthio, arylthio, sulfonyl, phosphoric acid, phosphate ester, phosphonic acid, and phosphonate ester.

The present disclosure provides a process for removing (and subsequently recovering) a metal species from a solution, which process comprises treating the solution with a polymer having ionisable groups, a ligand, and a precipitant, to form a complex. A key advantage of this process is its simplicity and sustainability, as well as its ease of commercial scale-up. A further advantage is the potential for high throughput and the removal of metal species from a solution containing high concentrations of metals. By the term “high concentrations of metals” is meant a solution with a concentration of the metal species to be removed of less than or equal to about 50,000 ppm. Preferably the concentration of metal species to be removed is greater than about 100 ppm (e.g. from 105 ppm) to about 50,000 ppm, more preferably the concentration of metal species to be removed is about 200 ppm to about 50,000 ppm.

The process may be used to recover metal species (e.g. metallic ions) from industrial effluent and process streams. It can be used in a wide variety of industries for the removal, recovery, and concentration of metal-containing ions from process streams, particularly aqueous process streams. The process finds particular application in the removal and recovery of metal species from pharmaceutical waste streams. As noted above, there is an economic and environmental incentive behind such removal and recovery. Pharmaceutical processes use a variety of precious metal-bearing catalysts in the manufacture of drugs and other products and the ability to recover and recycle such precious metals is desirable from both an economic and environmental perspective.

For ease of reference, these and further features of the present disclosure are now discussed under appropriate section headings. However, the teachings under each section are not limited to the section in which they are found. The skilled person will appreciate that such teachings should be taken in combination as set out in the appended claims and Examples below. Unless defined otherwise, all technical and scientific terms used herein have the same meaning as commonly understood by one of ordinary skill in the art to which the disclosure belongs.

### Metal Species-Containing Solution

The term “metal species” is used herein to refer to metal or metallic ions. The terms “metal” and “metallic” are used interchangeably herein. A metal or metallic ion is a metal-containing ion. This may be a monatomic metal ion or a polyatomic ion in which at least one of the atoms is a metal ion. Thus, a metallic ion may be a metal anion or a metal cation, or a complex anion that comprises a metal, such as a chromate, dichromate, ferricyanide and permanganate, or indeed a complex cation which comprises a metal.

The valency of the metal species is not limited. The metal species may be monovalent, i.e. a monocation or a monoanion, or it may have a valency of two or more including dications, trications, tetracations, pentacations, hexacations, dianions, trianions, tetranions, pentanions and hexanions. The process of the present disclosure is particularly beneficial for the removal of multiple metal species from a solution, including different metal species. Consequently, the valency of the metal species may be a mixture and not defined by a single value, for example a mixture of monovalent and divalent or higher species.

In various embodiments the solution to be treated comprises a plurality of metal species, and the plurality of metal species comprises a first metal species and at least one further metal species that is different from the first metal species, wherein the process is for removing at least the first metal species from the plurality of metal species in the solution. By the term “different” is meant a different polarity and/or a different metal type, preferably different means metal type such that the metal species in solution have the same polarity, i.e. all cations or all anions. The process may also remove the at least one further metal species from the plurality of metal species in the solution.

As noted in the preceding paragraph, in terms of the charges of the first metal species and at least one further metal species, these are generally of the same polarity. In other words, it is generally the case that the process separates a positively charged metal species from or with one or more other positively charged metal species, or alternatively, the process separates a negatively charged metal species from or with one or more other negatively charged metal species.

The valency of the first metal species and the at least one further metal species need not be the same. The species may be monovalent or have a valency of two or more as defined above. However, a particular advantage of the process is that it is able to separate multiple charged species from a single solution. In some embodiments, therefore, the first metal species and the further metal species have the same valency and same polarity; such metal species may be metallic cations including monocations, dications, trications, tetracations, pentacations, hexacations, or the like.

The removal and recovery of noble metals and rare-earth metals is of particular interest. In preferred embodiments, the metal species is therefore selected from noble metal species and rare-earth metals. The term “noble metal” is used herein to refer to a metal selected from ruthenium (Ru), rhodium (Rh), palladium (Pd), silver (Ag), osmium (Os), iridium (Ir), platinum (Pt), gold (Au), mercury (Hg), rhenium (Re) and copper (Cu). The term “rare earth metal” is used herein to refer to a metal selected from scandium (Sc), yttrium (Y), lanthanum (La), cerium (Ce), praseodymium (Pr), neodymium (Nd), promethium (Pm), samarium (Sm), europium (Eu), gadolinium (Gd), terbium (Tb), dysprosium (Dy), holmium (Ho), erbium (Er), thulium (Tm), ytterbium (Yb) and lutetium (Lu).

Preferably, the noble metal species is selected from platinum group species, copper species, gold species, silver species, or a combination thereof, more preferably the noble metal species is selected from platinum group species, gold species, silver species, or a combination thereof. The term “platinum group species” is used herein to refer to the six platinum group metals, namely ruthenium, rhodium, palladium, osmium, iridium, and platinum. The removal and recovery of platinum group species and gold species is of particular interest for the process of the present disclosure. Also of interest is the recovery of copper species.

In various embodiments, the metal species is a metallic cation, preferably a noble metal cation where the noble metal is as defined above or a rare earth metal cation where the rare earth metal is as defined above. In preferred embodiments, the noble metal cation is selected from platinum group cations, gold cations, silver cations, copper cations, or a combination thereof. The removal and recovery of platinum group species is of particular interest, specifically from waste streams during the manufacture and use of catalysts in pharmaceutical processes or the like. Hence, in various embodiments, the process of the present disclosure is for removing platinum group cations, gold cations, silver cations, or a combination thereof from a solution, preferably the process is for removing one or more platinum group cations from a solution.

Also of interest is the removal and recovery of rare earth metals including the recovery of heavy metals during the soil washing of contaminated land, and scandium recovery from rare earth processing. Accordingly, in some embodiments the process of the present disclosure is for removing rare earth metal ions, preferably scandium cations, from a solution. The solution to be treated in such embodiments may comprise a solution from a rare earth processing stream.

The solution which is treated in the process of the present disclosure comprises the metal species as defined above and a solvent. The solvent may be a single solvent or a mixture of different solvents. The metal species may further be at least partially dissolved in said solvent, although the present disclosure is not limited in this respect.

In various embodiments, the solvent comprises water and preferably, the solvent is aqueous. The term “aqueous” is used herein to refer to a solution containing at least 50 wt % water, based on the total weight of the solution. Other solvents may be present in addition to water, for instance one or more organic solvents.

When the solvent comprises one or more organic solvents, the organic solvent may be a polar organic solvent, for instance a polar protic solvent such as an alcohol or a carboxylic acid, a polar aprotic solvent such as acetonitrile, acetone, tetrahydrofuran (THF), or dimethyl sulfoxide (DMSO), an apolar organic solvent, for instance a hydrocarbon solvent such as pentane, hexane, toluene, or benzene, or a combination thereof. When the solvent comprises one or more organic solvents, the organic solvent is typically present at no more than about 20 wt % of the total solution, preferably no more than about 15 wt % of the total solution. For example, an aqueous solvent comprising no more than about 10 wt % of organic solvent may be used.

The metal species may be at least partially dissolved in the solvent; the metal species and solvent being defined above. The metal species may, for instance, be at least partially dissolved in the solvent prior to the start of the process of the present disclosure. In this respect, the metal species-containing solution may be a natural resource such as a river, lake or sea, and/or may comprise wastewater from an agricultural or industrial process. Alternatively, the solution may be an industrial effluent or a process stream. In various embodiments, the solution may be from an electronic plating process, e.g. the electronic plating bath. In various embodiments, the solution may be a waste stream produced during an industrial process, e.g. in the manufacture of catalysts or the like, or it may be a mixed metal aqueous waste stream produced during the preparation of an organic (e.g. pharmaceutical) product. Pharmaceutical processes use a variety of precious metal-bearing catalysts in the manufacture of drugs and other products. For example, palladium is widely used to facilitate cross-couplings, rhodium is used in hydroformylation reactions, and platinum is used to perform asymmetric hydrogenations.

In addition to the metal species and the solvent, the solution may comprise one or more further components. Such components are not limited because they depend on the source of the solution to be treated. The presence of one or more further components does not alter the beneficial results observed with the process of the present disclosure.

### The Complex

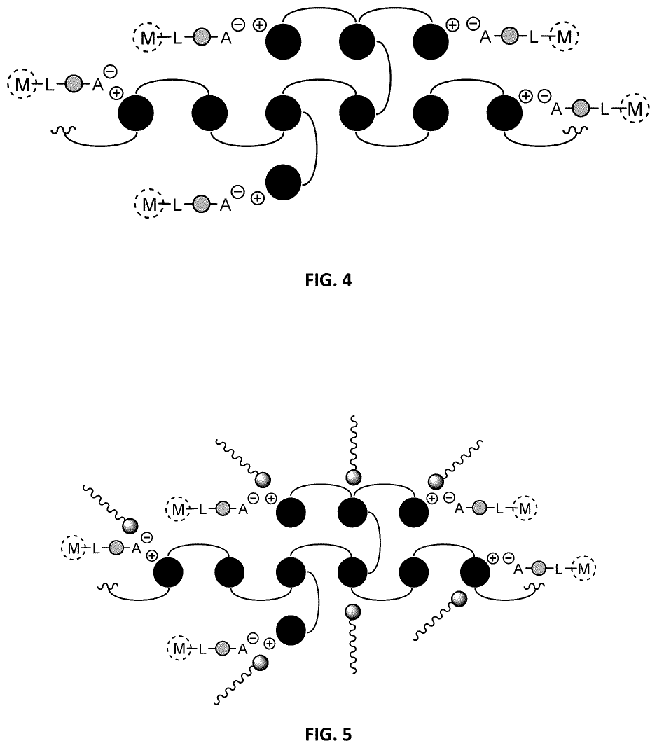

In the process of the present disclosure, the metal species-containing solution as defined above is treated with a polymer comprising ionisable groups, and a ligand, to form a complex. By the term “complex”, as used herein, is meant a molecular entity formed by the association of the polymer, ligand, and metal species. A representative complex is shown in FIGS. 4 and 5. The ligand is preferably electrostatically bound with the polymer, i.e. the ligand is not covalently bonded with the polymer. The ligand is not a functional group of the polymer, but a compound associated electrostatically therewith. The nature of the electrostatic or non-covalent association between the polymer and ligand is not limited; it may be dipole-dipole interactions, London dispersion forces, hydrogen bonding, ionic bonding or a combination thereof.

In various embodiments, the complex comprises a positively charged species formed from the polymer and a negatively charged species formed from the ligand. In various embodiments, the complex comprises a negatively charged species formed from the polymer and a positively charged species formed from the ligand. In various embodiments, the complex comprises a combination of positively charged species and negatively charged species from both the polymer and ligand. FIG. 4 shows a complex comprising a positively charged species formed from the polymer and a negatively charged species formed from the ligand but the present disclosure is not limited in this respect. The complex further comprises the metal species, bound with at least one group of the ligand. The nature of the interaction between the metal species and ligand is discussed further below.

In various embodiments, the acidic or basic group(s) on the ligand is at least ionically bonded with the one or more ionisable groups of the polymer. As the skilled person will appreciate, the formation of ionic bonds between the polymer and ligand results in the formation of a salt. Hence, the process of the present disclosure may include a step of mixing the polymer with the ligand to form a salt, wherein the salt comprises a positively charged species formed from the polymer and a negatively charged species formed from the ligand, or a negatively charged species formed from the polymer and a positively charged species formed from the ligand. The salt may be formed in-situ, i.e. during treating the metal-containing species solution with the polymer, ligand, and precipitant, to form the complex, or the salt may be formed prior to the treatment step such that the polymer and ligand are treated into the metal-containing species solution in the form of a salt. The process of the present disclosure is not limited in this respect.

The polymer, ligand, and precipitant may therefore be added to the metal species-containing solution in any order, and one or more of the polymer, ligand, and precipitant, may be pre-mixed prior to their addition to the metal species-containing solution. Thus, the process may comprise treating the solution with the polymer comprising ionisable groups, and then treating the solution with the ligand and/or the precipitant. Alternatively, the process may comprise treating the solution with the ligand, and then treating the solution with the polymer and/or the precipitant. Alternatively, the process may comprise treating the solution with the precipitant, and then treating the solution with the polymer and/or the ligand. In each of the above, it is preferable for the precipitant to be added after the polymer and/or the ligand.

In some embodiments, the solution may be treated with the polymer, ligand and/or precipitant simultaneously. In other embodiments, the polymer and ligand may be pre-mixed, and the solution treated with the pre-mixed polymer and ligand prior to the addition of the precipitant to form the complex. When the polymer and ligand are pre-mixed, a salt may be formed as discussed above.

In preferred embodiments, the polymer comprising ionisable groups is mixed with the ligand to form a salt, wherein the salt comprises a positively charged species formed from the polymer and a negatively charged species formed from the ligand, or a negatively charged species formed from the polymer and a positively charged species formed from the ligand. When the salt is formed, it will be understood that it is the reaction product of a neutralization reaction between an acid and a base. Thus, the formation of a salt may require the pH of a solution to be adjusted, i.e. increased or decreased, to produce the desired result. FIG. 3 is a representation of a polymer-ligand salt when the ionisable groups on the polymer are basic, although the present disclosure is not limited in this respect.

In preferred embodiments, the salt is in the liquid phase, and more preferably, the liquid phase salt is an aqueous salt solution (the term “aqueous” being defined as above). The pH of the solution containing the polymer with ionisable groups and the ligand is not critical to the process of the present disclosure. This may be described as the ‘salt solution pH’. The skilled person will be aware that different salts of different polymers and ligands would be prevalent within different pH ranges. When pH adjustment is, however, required to form the polymer-ligand salt, the solution containing the polymer with ionisable groups and the ligand may be adjusted to a pH of at least about 7. If the salt is prepared prior to treating the metal species-containing solution with the polymer and ligand, the pH of the salt solution may therefore at least about pH 7 and/or adjusted to a pH of at least about 7. The skilled person is aware of suitable pH-adjusting agents and processes for using same. For example, to reduce the pH the skilled person may add an acidic solution and to increase the pH the skilled person may add a basic solution.

Once the polymer-ligand salt is formed (either in-situ or in a pre-mix step), the pH of the salt-containing solution is not critical to the process of the present disclosure. This may be described as the ‘complexation pH’. In some embodiments, however, it may be beneficial to control the complexation pH. This may be beneficial in terms of maximising efficiency of the process. Without wishing to be bound by theory, the inventors believe that the control of the complexation pH may be beneficial in the formation of the complex. Hence, it may be advantageous for the pH to be monitored and optionally adjusted after the metal species-containing solution includes the polymer-ligand salt (either via in-situ salt formation or after treating the solution with the salt).

In some embodiments, it may be beneficial to adjust the pH prior to addition of the precipitant. This may be described as the “precipitation pH”. Without wishing to be bound by theory, the inventors believe that the control of the precipitation pH may be beneficial in the formation of the aggregate. Such pH monitoring and adjustment may, for instance, promote the binding of the precipitant to the metal species and/or polymer.

As noted above, the skilled person is aware of suitable pH-adjusting agents and processes for using same. The skilled person is also aware of suitable methods for monitoring pH; for example, the pH may be monitored with a pH probe.

In various embodiments the process may thus comprise mixing the polymer with the ligand to form a salt; wherein the salt comprises a positively charged species formed from the polymer and a negatively charged species formed from the ligand, or a negatively charged species formed from the polymer and a positively charged species formed from the ligand; and optionally adjusting the pH of the salt solution. The pH adjustment will be prior to treating the solution with the precipitant. The pH may be adjusted to less than about 7 when the salt comprises a positively charged species formed from the polymer and a negatively charged species formed from the ligand. Alternatively, the pH may be adjusted to greater than about 7 when the salt comprises a negatively charged species formed from the polymer and a positively charged species formed from the ligand.

When the salt is formed as a pre-mix step, the process may comprise:
(i) mixing the polymer with the ligand to form a salt; wherein the salt comprises a positively charged species formed from the polymer and a negatively charged species formed from the ligand, or a negatively charged species formed from the polymer and a positively charged species formed from the ligand;
(iia) treating the solution with the salt formed in step (i);
(iib) optionally adjusting the pH of the product of step (iia) to a pH of less than about 7 when the salt comprises a positively charged species formed from the polymer and a negatively charged species formed from the ligand, or to a pH of greater than about 7 when the salt comprises a negatively charged species formed from the polymer and a positively charged species formed from the ligand; and
(iic) treating the resulting product with the precipitant.

As noted above, adjusting pH of a solution is known in the art, it may involve treating the solution with an acidic or alkaline solution. The acid may be selected from an inorganic acid, a sulfonic acid, a carboxylic acid, and a halogenated carboxylic acid, or a combination thereof. When the ligand comprises at least one acidic group, it may be used to adjust (i.e. reduce) the pH. This is advantageous as it reduces the need for additional reagents and process complexity. The process is not, however, limited to the use of the ligand for pH adjustment and any suitable acidic solution may be used.

The base may be selected from hydroxides such as sodium, potassium, ammonium, calcium, magnesium, barium, aluminium, iron, zinc, and lithium. When the polymer comprises at least one basic group, it may be used to adjust (i.e. increase) the pH. This is advantageous for the same reasons as using the ligand for pH reduction. The process is not, however, limited to the use of the polymer for pH adjustment and any suitable basic solution may be used.

As the skilled person will appreciate, the relative amounts of the polymer with ionisable groups, the ligand, and the precipitant will depend upon the solution being treated as well as the metal species being removed, and the optimum amounts of polymer, ligand and precipitant for that particular system. In various embodiments, the molar ratio of monomer units of the polymer to the ligand is defined such that there is an excess of ionisable groups from the monomer units to the acidic/basic group(s) on the ligand. The molar ratio of the monomer units of the polymer to the ligand may, for example, be greater than 1:1. In alternative embodiments, the molar ratio of monomer units of the polymer to the ligand is defined such that there is an excess of group(s) on the ligand to the ionisable groups on the polymer. The molar ratio of the monomer units of the polymer to the ligand may, for example, be less than 1:1. As the polymer and/or ligand may include multiple acidic and/or basic groups, in various embodiments, the molar ratio of the monomer units of the polymer to the ligand is from about 1:4 to about 8:1, preferably from about 1:3 to about 6:1.

The ratio of the molar concentration of the polymer-ligand salt to the molar concentration of the precipitant in the solution may be vary from case to case and may be any suitable ratio. Often however, the ratio of the molar concentration of the polymer-ligand salt to the molar concentration of the precipitant in the solution is from about 1:4 to about 4:1.

The molar concentration of the polymer-ligand salt in the solution containing the metal species may vary from embodiment to embodiment, but it may for instance be at least equal to the molar concentration of metal species in the solution. It could for instance be at least twice the molar concentration of metal species in the solution or even at least fifteen times the molar concentration of the metal species in the solution. For instance, the ratio of the molar concentration of the polymer-ligand salt to the molar concentration of the metal species in solution may be from about 1:2 to about 1:15.

A key advantage of the process of the present disclosure is the efficient and effective removal of metal species from a solution. Without wishing to be bound by theory, the inventors believe that this is facilitated by the unique complex formed by the polymer comprising ionisable groups, the ligand, and the metal species in solution on addition of the polymer and ligand to the solution. In particular, a group on the ligand binds the metal species, as shown schematically in FIGS. 4 and 5, and the ionisable groups on the polymer interact with the acidic/basic group(s) on the ligand, as shown schematically in FIGS. 3, 4 and 5.

The interaction between the polymer and the ligand has been discussed above. In particular, there is a charged species formed by the ionisable groups on the polymer and an oppositely charged species formed by one or more groups on the ligand. The ligand further comprises one or more groups that bind the metal species. The binding of the metal species is discussed below.

Each of the polymer with ionisable groups, the ligand and the precipitant will now be discussed in more detail. It will be understood that such discussion is combinable with the discussion above including the complex and aggregate so formed and the preparation of a salt.

Polymer with Ionisable Groups

The term “polymer comprising ionisable groups” is used interchangeably herein with “polymer with ionisable groups”, and refers to any polymer comprising a functional group that is ionised or that is capable of being ionised, i.e. a functional group that can carry a charge. As discussed above, the process is typically performed in an aqueous solvent. The polymer with ionisable groups is therefore preferably a water-soluble polymer.

The polymer may be supplied neat or in a solvent. Poly(ethyleneimine), for example, is available from Sigma Aldrich as a viscous liquid containing less than 1.0 wt % water (i.e. neat) or as an aqueous solution (containing 50 wt % or more of water). When the polymer is supplied neat, it may be dissolved in one or more solvents prior to its addition to the solution comprising the metal species and/or the ligand. Suitable solvents are known to a person skilled in the art and are discussed above. In preferred embodiments, the polymer is dissolved in an aqueous solvent prior to use. When the polymer is supplied in a solvent, said solvent is preferably aqueous. As the polymer is used in a solution, a change in the pH of the solution may be necessary for the ionisable group to become charged. In particular, the ionisable groups may become charged when the polymer is present in solution with the ligand, typically this solution is aqueous. The term “aqueous” is defined above.

The term “polymer comprising ionisable groups” thus encompasses anionic polymers, i.e. a polymer comprising a negatively charged functional group; cationic polymers, i.e. a polymer comprising a positively charged functional group; and a polyelectrolyte, i.e. a polymer comprising a functional group that can ionise in solution. The polymer comprising ionisable groups may further be a polymer comprising two or more different ionisable groups, i.e. encompasses ampholytic polymers. The term “ampholytic polymer” as used herein, refers to a polyelectrolyte comprising macromolecules containing both cationic and anionic groups, or corresponding ionisable groups. An ampholytic polymer in which ionic groups of opposite charge are incorporated into the same pendant groups may be called, depending on the structure of the pending groups, a zwitterionic polymer, polymeric inner salt, or polybetaine.

The ionisable groups of the polymer may be basic, acidic, or a combination thereof. When the ionisable groups of the polymer are basic, the ligand comprises at least one acidic group. When the ionisable groups of the polymer are acidic, the ligand comprises at least one basic group. The skilled person is aware of a variety of acidic and basic groups that electrostatically or otherwise interact with one another in a non-covalent manner. The skilled person is further readily able to obtain or synthesise a polymer which bears that particular ionisable group for use in accordance with the process of the present disclosure. Polymers bearing such ionisable groups are known or commercially available.

Polymers bearing suitable ionisable groups are also able to be readily synthesised by the person skilled in the art using routine polymer synthesis methods such as routine coupling chemistry. The ionisable groups are typically attached to the polymer backbone, and attachment of such groups (either directly or via a protected version which is deprotected at a later point in time) can be carried out either prior to or after polymerisation. For example, an ionisable group suitable for interacting with a group on the ligand may be attached to a monomer unit and then polymerisation of the monomer unit may be subsequently performed. If necessary, deprotection of a protected version of the ionisable group may be performed after polymerisation. Alternatively, the ionisable group (or a protected version thereof) may be attached to the polymer after polymerisation, for instance by attaching the groups to the polymer backbone. Deprotection may be performed if necessary to provide the polymer with ionisable groups. The skilled person will be familiar with suitable protection and deprotection mechanisms.

In the present disclosure the terms “basic” and “basic group” are used interchangeably to refer to a Brønsted-Lowry base, and the terms “acidic” and “acidic group” are used interchangeably to refer to a Brønsted-Lowry acid. In other words, the groups are acidic or basic by virtue of the way in which they react with one another when in the solution being treated, preferably an aqueous solution. The acid may be considered a proton donor, and the base may be considered a proton acceptor. This definition is expressed in terms of the following equilibrium expression:

acid+base≈conjugate base+conjugate acid

When basic, the ionisable groups of the polymer may be N-containing groups such as amine groups, imine groups or N-heterocycles. Suitable N-heterocycles are aliphatic or aromatic N-heterocycles. For example, aziridine, azolidine, piperidine, azepane, pyrrole, imidazole, thiazole, or pyridine.

Preferably, the basic ionisable groups of the polymer may be amine groups, such as aliphatic amine groups. The amine groups may be primary, secondary, tertiary or a combination thereof. In linear polyethyleneimine, for example, all amine groups are secondary amines (excluding any terminal amines) but branched PEIs contain primary, secondary and tertiary amine groups. Particularly preferred as N-containing groups of the polymer are branched aliphatic amine groups.

In various embodiments of the ionisable groups being N-containing groups, the polymer comprises an organic polymer with one or more amine, imine or N-heterocycle groups, such as aliphatic amine groups. Examples include, but are not limited to, poly(ethyleneimine), polyvinylamine, polyallylamine, chitosan, polylysine, polyarginine, or a combination thereof. Such polymers are known in the art. Where these polymers include aliphatic hydrocarbon chains, they may be linear or branched. Preferably, the aliphatic hydrocarbon chains of the polymer comprise branching.

The polymer may be a homopolymer, copolymer or an interpolymer. As used herein, the term “interpolymer” refers to a complex comprising at least two polymers. In such interpolymers, one or more of the constituent polymers may be a homopolymer or a copolymer. Without wishing to be bound by theory, it is believed that the complex between the at least two polymers in an interpolymer arises due to non-covalent interactions.

In preferred embodiments, the polymer comprises aliphatic monomer units with one or more amine, imine or N-heterocycle groups. In particularly preferred embodiments, the polymer is selected from polyethyleneimine, polyvinylamine, polyallylamine, chitosan, polylysine, polyarginine, or a combination thereof. The Examples employ polyethyleneimine, polyallylamine or chitosan as basic polymers but the present disclosure is not limited to these polymers. As the skilled person will appreciate, these polymers are employed to demonstrate the generalizable principle of the invention when the ionisable groups of the polymer are basic.

When acidic, the ionisable groups of the polymer may be O-containing groups, P-containing groups, and/or S-containing groups. Preferably, the ionisable groups of the polymer may be selected from carboxyl groups, sulfonic acid groups, phosphoric acid groups, phosphinic acid groups, phosphonic acid groups, or a combination thereof. Particularly preferred are carboxyl groups, sulfonic acid groups, or a combination thereof.

In various embodiments of the ionisable groups being selected from O-containing groups, P-containing groups, and/or S-containing groups, the polymer comprises an organic polymer with one or more carboxyl groups, sulfonic acid groups, phosphoric acid groups, phosphinic acid groups, phosphonic acid groups, or a combination thereof. The organic polymer may be linear or branched. In preferred embodiments, the polymer comprises an organic polymer with one or more carboxyl groups and/or sulfonic acid groups. Examples of polymers with carboxyl groups include, but are not limited to, polyolefins substituted with carboxyl groups, polyesters substituted with carboxyl groups, and polysulfides with carboxyl groups. Examples of polymers with sulfonic acid groups include, but are not limited to, polyolefins substituted with sulfonate groups, polyesters substituted with sulfonate groups, polysulfides substituted with sulfonate groups, and poly(sodium styrene sulfonate). Where these polymers include aliphatic hydrocarbon chains, they may be linear or branched. Preferably, the aliphatic hydrocarbon chains of the polymer comprise branching. The polymer may be a homopolymer, copolymer or an interpolymer.

In various embodiments of the ionisable groups being acidic, the polymer comprises monomeric units which are aliphatic or aromatic hydrocarbons, and wherein the ionisable groups are carboxyl groups or sulfonic acid groups. In preferred embodiments, the polymer comprises poly(meth)acrylic acid, polyaspartic acid, polyglutamic acid, alginic acid, polyvinylsulfonic acid, polyphosphoric acid, or a combination thereof. These polymers may advantageously be combined with a ligand having at least one basic group which is a N-containing group. The Examples employ polystyrene sulfonic acid but the present disclosure is not limited to this polymer. As the skilled person will appreciate, this polymer was used to demonstrate the generalizable principle of the invention when the ionisable groups of the polymer are acidic.

The polymer with ionisable groups may have a weight average molecular weight, as measured by Gel Permeation Chromatography (GPC) with a suitable calibration standard (e.g. polystyrene), of from about 100 Da to about 1000 kDa. In preferred embodiments, the polymer with ionisable groups has a weight average molecular weight, as measured by GPC and calibration, of from about 200 Da to about 1000 kDa. In particularly preferred embodiments, the polymer with ionisable groups has a weight average molecular weight, as measured by GPC and calibration, of from about 1 kDa to about 1000 kDa.

It is understood that higher MW polymers may improve metal species recovery.

For example, the polymer may comprise an organic polymer with N-containing groups selected from amines, imines and N-heterocycles, preferably amine groups, and have a weight average molecular weight as measured by GPC and calibration of from about 100 Da to about 1000 kDa, preferably from about 200 Da to about 1000 kDa. In the mirror system, the polymer may comprise an organic polymer with carboxyl, sulfonic acid, phosphonic acid, phosphoric acid and/or phosphinic acid groups, preferably carboxyl and/or sulfonic acid groups, and have a weight average molecular weight as measured by GPC and calibration of from about 100 Da to about 1000 kDa, preferably from about 200 Da to about 1000 kDa.

### Ligand

By the term “ligand” is meant a molecule which is capable of coordinating with at least the polymer and the metal species in the complex. The coordination between the ligand and the polymer is at least electrostatic, via at least the acidic/basic groups on each molecule, but is otherwise not limited; the electrostatic coordination may be via dipole-dipole interactions, London dispersion forces, hydrogen bonding, ionic bonding, or a combination thereof. The ligand does not form a covalent bond with the polymer.

The coordination between the ligand and the metal species is not limited; it may electrostatic, or covalent where covalent includes coordinative covalent bonding. When the coordination is electrostatic, it may be via dipole-dipole interactions, London dispersion forces, hydrogen bonding, ionic bonding, or a combination thereof; when the coordination is covalent, the ligand may be an electron-pair donor or an electron-pair acceptor with the metal species, typically the ligand is an electron-pair donor.

As the ligand coordinates with both the polymer and the metal species, it is at least a bidentate or bifunctional ligand. This is shown in the Figures with the notation “L” and “A” for the functional groups. The ligand may coordinate with the polymer and/or metal species via two or more atoms and in various embodiments may therefore be bidentate/bifunctional, tridentate/trifunctional, or polydentate/polyfunctional.

The ligand comprises at least one acidic group or at least one basic group. The identity of this group is dependent upon the acidic/basic nature of the ionisable groups on the polymer or vice versa, since such groups interact to form the complex in solution with the metal species. The acidic and basic groups defined above for the polymer are also therefore applicable to the ligand. The acidic/basic group of the ligand is represented by “A” in the Figures.

For example, the acidic group on the ligand may be selected from a carboxyl group, a sulfonic acid group, a phosphoric acid group, a phosphinic acid group, a phosphonic acid group, or a combination thereof. Preferably the at least one acidic group on the ligand is a carboxyl group or a sulfonic acid group or a phosphonic acid group. When the ligand comprises an acidic group, the polymer may be an organic polymer with basic groups, such as N-containing groups defined above. In the mirror system, the basic group on the ligand may be selected from N-containing groups, preferably amine, imine or N-heterocycle groups defined above, and the polymer may be an organic polymer with acidic groups, such as carboxyl groups and/or sulfonic acid groups defined herein.

The ligand further comprises at least one group that binds the metal species. By the term “binds the metal species” is meant a group that coordinates with the metal species in solution. The coordination between the ligand and the metal species has already been explained above. This group is represented by “L” in the Figures.

The at least one acidic or at least one basic group on the ligand may be the same as the at least one group that binds the metal species, i.e. L may be the same as A. An example of this structure would be where the ligand included a plurality of thiol groups or carboxy groups (e.g. iminodiacetic acid) to bind the metal species, the thiol/carboxy groups being acidic and able to interact with one or more basic groups on the polymer; the basic groups being defined above (e.g. N-containing groups). Another example would be where the ligand included a plurality of amine groups (e.g. a thiourea or diethylenetriamine) to bind the metal species, the amine groups being basic and able to interact with one or more acidic groups on the polymer (e.g. carboxyl and/or sulfonic acid groups).

Alternatively, the ligand may comprise at least one acidic or at least one basic group (depending on the acidic/basic nature of the ionisable groups on the polymer), and a different group that binds the metal species, i.e. L may be different from A. An example of this structure would be a ligand including a sulfur atom (e.g. via a thiol group) to bind the metal species and an oxygen atom (e.g. via a carboxyl group) to interact with one or more basic groups on the polymer (e.g. a mercaptocarboxylic acid to interact with one or more N-containing groups on the polymer). A further example of this structure would be a ligand including a phosphorus atom (e.g. phosphonic acid group) to interact with one or more basic groups on the polymer and an oxygen atom or a N atom to bind with the metal species (e.g. via a carboxyl group or an amine group).

Another alternative is where the group(s) that bind the metal species include the acidic or basic group(s) within their structure. An example of this structure would be ligand including a sulfur atom and a nitrogen atom in a single functional group (e.g. a dithiocarbamate), or a ligand including a basic nitrogen and an acidic group (e.g. iminodiacetic acid).

Groups that bind the metal species may be selected according to the metal species that it is desired to remove. The skilled person is aware of suitable groups in this respect, and is readily able to select a particular functional group for binding to a particular metal species as well as obtain or synthesise a ligand which bears that particular group for use in accordance with the present disclosure. Suitable ligands with at least one group that binds a metal species are known or commercially available. The skilled person is also readily able to synthesise ligands bearing such groups using routine synthesis methods.

In various embodiments, the at least one group on the ligand that binds the metal species comprises a heteroatom. The heteroatom may otherwise be referred to as a “donor atom” and is selected from sulfur, phosphorus, nitrogen, and oxygen. Consequently, the at least one group on the ligand that binds the metal species comprises at least one sulfur atom, phosphorus atom, nitrogen atom, oxygen atom, or a combination thereof. In preferred embodiments the at least one group on the ligand that binds the metal species comprises at least one nitrogen atom, sulphur atom, oxygen atom, or a combination thereof.

The at least one group on the ligand that binds the metal species may comprise at least one thiol, thioether, thioamide, thioester, dithiocarbamate, thionyl, phosphine, phosphite, phosphate, amine, imine, amide, pyridine, alcohol, ester, ketone, carboxylic acid, or a combination thereof. In preferred embodiments the at least one group on the ligand that binds the metal species comprises at least one thiol, thioether, dithiocarbamate, thioamide, amine, imine, amide, alcohol, ether, ester, carboxylic acid, or a combination thereof. In more preferred embodiments, the at least one group on the ligand that binds the metal species comprises at least one thiol, thioether, dithiocarbamate, amine, alcohol, ether, carboxylic acid, or a combination thereof.

For example, the polymer may be an organic polymer with basic groups, such as N-containing groups defined herein, and the ligand may comprise an acidic group selected from a carboxyl group, a sulfonic acid group, a phosphoric acid group, a phosphinic acid group, a phosphonic acid group, or a combination thereof, along with a group that binds the metal species selected from thiol, thioether, thioamide, thioester, dithiocarbamate, thionyl, phosphine, phosphite, phosphate, amine, imine, amide, N-heterocycle as defined above, alcohol, ester, ketone, carboxylic acid, or a combination thereof. Preferably the at least one acidic group on the ligand may be a carboxyl group, a sulfonic acid group, or a phosphonate group, and the at least one group on the ligand that binds the metal species is selected from thiol, thioether, dithiocarbamate, thioamide, amine, imine, amide, alcohol, ether, ester, carboxylic acid, or a combination thereof. In such embodiments, the precipitant is preferably an anionic surfactant or an organic polymer with at least one acidic group.

In another embodiment, the polymer may be an organic polymer with basic groups, such as N-containing groups defined herein, and the at least one acidic group on the ligand may be a phosphonic acid group, a phosphinic acid group, or a phosphoric acid group, and the at least one group that binds the metal species is selected from thiol, thioether, thioamide, thioester, dithiocarbamate, thionyl, amine, imine, amide, N-heterocycle as defined above, alcohol, ester, ketone, carboxylic acid, or a combination thereof. Preferably the at least one acidic group on the ligand may be a phosphonic acid group or a phosphinic acid group, and the at least one group that binds the metal species is selected from dithiocarbamate, amine, imine, amide, N-heterocycle as defined above, alcohol, ester, ketone, carboxylic acid, or a combination thereof. In such embodiments, the precipitant is preferably an anionic surfactant or an organic polymer with at least one acidic group.

In the mirror system, the polymer may be an organic polymer with acidic groups, such as carboxyl groups and/or sulfonic acid groups, and the ligand may comprise a basic group selected from N-containing groups such as amines, imines, N-heterocycles as defined above, or a combination thereof, along with a group that binds the metal species selected from thiol, thioether, thioamide, thioester, dithiocarbamate, thionyl, phosphine, phosphite, phosphate, amine, imine, amide, pyridine, alcohol, ester, ketone, carboxylic acid, or a combination thereof. Preferably the at least one basic group on the ligand may be an amine and the at least one group on the ligand that binds the metal species is selected from thiol, thioether, dithiocarbamate, thioamide, alcohol, ether, ester, carboxylic acid, or a combination thereof. In such embodiments, the precipitant is preferably a cationic surfactant or an organic polymer with at least one basic group.

In various embodiments, the acidic or basic group on the ligand is the same as the group that binds the metal species. Hence, the acidic or basic group may comprise at least one sulfur atom, phosphorus atom, nitrogen atom, oxygen atom, or a combination thereof, the heteroatom being the same as in the group that binds the metal species. In preferred embodiments, the acidic or basic group on the ligand comprises at least one nitrogen atom, sulphur atom, oxygen atom, or a combination thereof, the heteroatom being the same as in the group that binds the metal species. Aligned with the discussion above of the group on the ligand that binds the metal species, suitable N-containing groups are thioamides, dithiocarbamates, amines, imines, amides, and N-heterocycles as defined herein; suitable S-containing groups are thiols, thioethers, thioamides, thioesters, dithiocarbamates, and thionyls; suitable O-containing groups include thionyls, phosphites, alcohols, esters, ethers, esters, ketones, and carboxylic acids; and suitable P-containing groups include phosphines, phosphates, and phosphites. The skilled person will understand the overlap between the groups, namely because certain moieties, e.g. thioamides, include more than one heteroatom selected from nitrogen, oxygen, phosphorus and sulfur.

The term “phosphite” is used interchangeably herein with “phosphonate” and “phosphonic acid group”. The term “phosphate” is used interchangeably herein with “phosphoric acid group”.

In various embodiments, the ligand thus comprises at least two groups selected from thiols, thioethers, thioamides, thioesters, dithiocarbamates, thionyls, phosphines, phosphites, phosphates, amines, imines, amides, N-heterocycles, alcohols, ethers, esters, ketones, and carboxylic acids, wherein the two groups are the same. In preferred embodiments the ligand comprises at least two groups selected from dithiocarbamates, thioamides, amines, imines, alcohols, ethers, esters, and carboxylic acids, wherein the two groups are the same. In more preferred embodiments, the ligand comprises at least two groups selected from thioamides, amines, alcohols, and carboxylic acids, wherein the two groups are the same.

For example, the polymer may be an organic polymer with basic groups, such as N-containing groups defined herein, and the ligand may comprise two carboxylic acid groups. In such embodiments the precipitant is preferably an anionic surfactant or an organic polymer with acidic groups. In the mirror system, the polymer may be an organic polymer with acidic groups, such as carboxyl groups and/or sulfonic acid groups, and the ligand may comprise two groups selected from thioamides and amines, wherein the two groups are the same. In such embodiments the precipitant is preferably a cationic surfactant or an organic polymer with basic groups.

When the group that binds the metal species is different from the acidic or basic group on the ligand, the acidic or basic group may comprise a heteroatom selected from sulfur, phosphorus, nitrogen, and oxygen which interacts with the ionisable groups on the polymer which is the same or different from the heteroatom that binds the metal species. In preferred embodiments, the heteroatom in the acidic or basic group is different from the heteroatom that binds the metal species. For example, the heteroatom in the group that binds the metal species may be sulphur when the acidic or basic group comprises nitrogen, oxygen, phosphorus, or a combination thereof for the ionisable groups on the polymer, or the heteroatom in the group that binds the metal species may be nitrogen when the acidic or basic group comprises sulphur, oxygen, phosphorus or a combination thereof for the ionisable groups on the polymer. Similarly, the heteroatom in the group that binds the metal species may be oxygen when the acidic or basic group comprises phosphorus, nitrogen, sulfur, or a combination thereof for the ionisable groups on the polymer. Suitable N-containing groups, S-containing groups, P-containing groups, and O-containing groups are set out above.

In various embodiments, the ligand thus includes at least two groups selected from thiols, thioethers, thioamides, thioesters, dithiocarbamates, thionyls, phosphines, phosphites, phosphates, amines, imines, amides, N-heterocycles, alcohols, ethers, esters, ketones, and carboxylic acids, wherein the two groups are different. In preferred embodiments the ligand comprises at least two groups selected from thiols, thionyls, dithiocarbamates, thioamides, phosphites, amines, imines, alcohols, ethers, esters, and carboxylic acids, wherein the two groups are different. In other preferred embodiments the ligand comprises at least two groups selected from thiols, thionyls, dithiocarbamates, thioamides, amines, imines, N-heterocycles, phosphites, alcohols, ethers, esters, and carboxylic acids, wherein the two groups are different.

For example, the polymer may be an organic polymer with basic groups, such as N-containing groups defined herein, and the ligand may comprise at least two groups selected from thiols, thionyls, dithiocarbamates, N-heterocycles, phosphites, and carboxylic acids, wherein the two groups are different; the N-heterocycle is preferably one containing 1 to 5 carbon atoms. In the mirror system, the polymer may be an organic polymer with acidic groups, such as carboxyl groups and/or sulfonic acid groups, and the ligand may comprise at least two groups selected from thiols, thioamides, amines, N-heterocycles, carboxylic acids, phosphites, and imines, wherein the two groups are different.

In various embodiments, the ligand comprises at least one amine group and at least one thioyl group (e.g. L-cysteine). In such embodiments, the polymer is preferably an organic polymer as defined above with a carboxyl group, sulfonic acid group, or a combination thereof. The precipitant is preferably a cationic surfactant or an organic polymer with basic groups. Alternatively the polymer is an organic polymer comprising basic N groups and the precipitant is preferably an anionic surfactant; such embodiments are particularly useful for recovery of copper species.

In various embodiments, the ligand comprises at least two amine groups or at least two carboxylic acid groups, or a carboxylic acid group and a N-containing group such as an amine or N-heterocycle (e.g. glyphosate, picolinic acid, glycine or L-cysteine). In such embodiments, the polymer is preferably an organic polymer as defined above with respectively a carboxyl group, sulfonic acid group, or combination thereof, or a N-containing group such as an amine group. The precipitant is preferably an anionic, cationic or amphoteric surfactant.

In various embodiments, the ligand comprises at least one carboxylic acid and at least one thiol, thioether, thioamide, thioester, dithiocarbamate or thionyl. In such embodiments, the polymer is preferably an organic polymer as defined above. In preferred embodiments, the ligand comprises at least one carboxylic acid and at least one thiol, thioether or dithiocarbamate. In such embodiments, the polymer is preferably an organic polymer as defined above with at least one N-containing group such as an amine group. In particularly preferred embodiments, the ligand comprises at least one carboxylic acid and at least one thiol or thioether. The ligand may, for example, be a mercaptocarboxylic acid such as a C₂-C₄ mercaptocarboxylic acid.

In various embodiments, the ligand comprises a N-heterocycle, preferably containing 1 to 5 carbon atoms, and at least one group selected from thiols, thioethers, thioamides, thioesters, dithiocarbamates, and thionyls (e.g. trimercaptotriazine). In such embodiments, the polymer is preferably an organic polymer as defined above. The polymer can include a basic N-containing group or an acidic carboxyl or sulfonic acid group. In such embodiments, the precipitant is preferably an anionic surfactant or a polymer with oppositely charged groups to the ionizable groups forming the complex.

In various embodiments, the ligand comprises a phosphite (phosphonic acid group), and at least one group selected from amines, imines, amides, N-heterocycles, alcohols, ethers, esters, ketones, and carboxylic acids, preferably amines or carboxylic acids (e.g. glyphosate or 2-aminoethyl phosphonic acid). In such embodiments, the polymer is preferably an organic polymer as defined above. The polymer can include a basic N-containing group or an acidic carboxyl or sulfonic acid group. In such embodiments, the precipitant is preferably an anionic surfactant.

In addition to the above functional groups, whether to bind the metal species or interact with the ionisable groups on the polymer, the ligand typically comprises an organic hydrocarbon moiety. The organic hydrocarbon moiety comprises an aliphatic hydrocarbon group or an aryl hydrocarbon group and in preferred embodiments is a C₁-C₁₂ hydrocarbyl, for example a C₁-C₁₂ alkyl, aryl, alkaryl, cycloalkyl, heteroaryl, or heteroalkaryl. The terms alkyl, aryl, cycloalkyl and heteroaryl are defined hereinabove. The “alkaryl” and “heteroalkaryl” groups will be understood by the person skilled in the art as being defined by the passages relating to alkyls, aryls and heteroaryls. In particularly preferred embodiments, the ligand comprises a C₁-C₁₂ alkyl or heteroaryl (e.g. N-heterocycle containing 1 to 5 carbon atoms).

In various embodiments, the ligand is a C₁-C₁₂ hydrocarbyl comprising: (i) at least one carboxyl group, sulfonic acid group, phosphonic acid group, phosphoric acid group, phosphinic acid group, or a combination thereof; and (ii) at least one thiol, thioether, thioester, thioamide, dithiocarbamate, thionyl, phosphine, phosphite, phosphate, amine, imine, amide, pyridine, alcohol, ether, ester, ketone, carboxylic acid, or a combination thereof. Alternatively, the ligand is a C₁-C₁₂ hydrocarbyl and comprises at least one amine group and at least one thioyl or phosphonate group; at least two amine groups; at least two carboxylic acids; or at least one carboxylic acid and at least one amine, thiol, thioether, thioamide, thioester, dithiocarbamate, thionyl or phosphonate, or wherein the ligand comprises a C₁-C₁₀ heteroaryl and at least one thiol, thioether, thioester, thioamide, dithiocarbamate, thionyl, amine, imine, amide, alcohol, ether, ester, ketone, carboxylic acid, or a combination thereof.

In preferred embodiments, the ligand is a C₁-C₁₂ alkyl, aryl, alkaryl, cycloalkyl, heteroaryl, or heteroalkaryl comprising: (i) at least one carboxyl group, sulfonic acid group, phosphonic acid group, phosphoric acid group, phosphinic acid group, or a combination thereof; and (ii) at least one thiol, thioether, thioester, thioamide, dithiocarbamate, thionyl, phosphine, phosphite, amine, imine, amide, pyridine, alcohol, ether, ester, ketone, carboxylic acid, or a combination thereof. Alternative preferred embodiments are where the ligand is a C₁-C₁₂ alkyl and comprises at least one amine group and at least one thioyl or phosphonate group; at least two amine groups; at least two carboxylic acids; or at least one carboxylic acid and at least one amine, thiol, thioether, thioamide, thioester, dithiocarbamate, amine, thionyl, or phosphonate group; or wherein the ligand comprises a N-heterocycle containing 1 to 5 carbon atoms and at least one thiol, thioether, thioester, dithiocarbamate, thionyl, ester, ketone, carboxylic acid, or a combination thereof.

The above disclosures relating to the polymer will be understood by the skilled person to be combinable with the disclosures relating to the ligand. In particular, the skilled person will understand that the acidic group(s) on the ligand will correspond with the basic group(s) on the polymer, and the basic group(s) on the ligand will correspond with the acidic group(s) on the polymer.

### Precipitant

The process of the present disclosure involves the use of a precipitant. The precipitant comprises at least one group that binds the metal species and/or the polymer, and at least one hydrophobic moiety. As used herein, the term precipitant refers to a compound that causes precipitation of at least the polymer-ligand-metal species (i.e. complex) from the solution. In various embodiments, the precipitant is a compound that causes the complex formed from the polymer with ionisable groups, the ligand, and the metal species, to precipitate from the solution.

The precipitant may comprise one or more hydrophobic moieties, such as two or more hydrophobic moieties. Suitable hydrophobic moieties will be known to the person skilled in the art. The hydrophobic group is often referred to as the tail group. The tail usually comprises a hydrocarbon chain, i.e. a chain comprising carbon atoms, which may be branched, linear or aromatic in nature.

The at least one group that binds the metal species comprises a heteroatom. The heteroatom may otherwise be referred to as a “donor atom” and is selected from sulfur, phosphorus, nitrogen, and oxygen. Consequently, the at least one group on the precipitant that binds the metal species comprises at least one sulfur atom, phosphorus atom, nitrogen atom, oxygen atom, or a combination thereof. In preferred embodiments the at least one group on that binds the metal species comprises at least one nitrogen atom, sulphur atom, oxygen atom, or a combination thereof.

As will be understood by the person skilled in the art, this means that the precipitant could be a polymer containing ionisable groups, said ionisable groups being of opposite charge to the complex-forming polymer described herein. In this respect, the precipitant could be a polymer with ionisable groups as defined hereinabove, provided that said ionisable groups were of opposite charge to the ionisable groups of the complex-forming polymer with ionisable groups.

Examples of polymers with carboxyl groups include, but are not limited to, polyolefins substituted with carboxyl groups, polyesters substituted with carboxyl groups, and polysulfides with carboxyl groups. Examples of polymers with sulfonic acid groups include, but are not limited to, polyolefins substituted with sulfonate groups, polyesters substituted with sulfonate groups, polysulfides substituted with sulfonate groups, and poly(sodium styrene sulfonate). In preferred embodiments, the polymer comprises poly(meth)acrylic acid, polyaspartic acid, polyglutamic acid, alginic acid, polyvinylsulfonic acid, polyphosphoric acid, or a combination thereof. Examples of polymers with N-containing groups include, but are not limited to, organic polymers with one or more amine, imine or N-heterocycle groups, such as aliphatic amine groups. Examples include, but are not limited to, poly(ethyleneimine), polyvinylamine, polyallylamine, chitosan, polylysine, polyarginine, or a combination thereof. Where these polymers include aliphatic hydrocarbon chains, they may be linear or branched. Preferably, the aliphatic hydrocarbon chains of the polymer comprise branching. The polymer may be a homopolymer, copolymer or an interpolymer.

In various embodiments the precipitant is a surfactant. The term surfactant, as used herein, refers to an amphiphilic compound comprising the hydrophobic moiety defined above and a hydrophilic moiety. The hydrophilic moiety is often referred to as the head group and usually comprises an ionic functional group, such as an anionic functional group or a cationic functional group, or a non-ionic group. Surfactants are widely used to reduce the surface tension of a liquid to which it is added.

When the precipitant is a surfactant in the process of the present disclosure, it is typically an ionic surfactant. The ionic surfactant may comprise a hydrocarbon chain terminating in an ionic functional group. In such embodiments, the surfactant may be an anionic, amphoteric, or cationic surfactant, or mixtures thereof. The precipitant comprises at least one group that binds the metal species and/or the polymer. Consequently, when the precipitant is a surfactant, the type of surfactant will depend on whether the metal species and/or ionisable groups of the polymer comprises a positive charge, a negative charge, or a combination thereof. Generally, when the metal species and the ionisable groups are positively charged, the surfactant comprises an anionic surfactant. On the other hand, when the metal species and the ionisable groups are negatively charged, the surfactant comprises a cationic surfactant. An anionic surfactant is typically a compound comprising a hydrocarbon chain terminating in an anionic functional group. A cationic surfactant is typically a compound comprising a hydrocarbon chain terminating in a cationic functional group. The hydrocarbon chain may be an unsubstituted C₅-C₃₅ alkyl group for each type of surfactant.

In various embodiments the ionisable groups of the polymer are basic and the precipitant is selected from an anionic surfactant, a cationic surfactant, a polymer with at least one acidic group, and mixtures thereof. The metal species may further comprise metallic cations. The anionic surfactant may comprise an anionic functional group selected from a sulphate, sulfonate, phosphate, phosphate and carboxylate group, and a C₅-C₃₅ alkyl group. In preferred embodiments, the anionic surfactant comprises an anionic functional group selected from a sulphate, sulfonate, phosphate, phosphate and carboxylate group, and a C₅-C₂₀ alkyl group. For instance, the anionic surfactant may be a C₅-C₂₀ alkyl or aryl sulphate or sulphonate, and the polymer with acidic groups may be a polyvinylsulfonic acid.

As used herein, the term “sulphate” represents a group of formula: —SO₄²⁻. As would be understood by the skilled person, a sulphate group can exist in protonated and deprotonated forms (for example, —SO₄H⁻ or —SO₄²⁻), and in salt forms (for example, —(SO₄)X₂ or —(SO₄)X, wherein X is a monovalent or divalent cation). X may for instance be an alkali metal cation or a cationic alkaline earth metal. Thus, X may be Na⁺, K⁺, Ca²⁺ or Mg²⁺, for instance.

As used herein, the term “sulfonate” or “sulfonic acid” represents a group of formula: —S(═O)₂O⁻. As would be understood by the skilled person, a sulfonate group can exist in protonated and deprotonated forms (for example, —S(O)₂OH or —S(═O)₂O⁻), and in salt forms (for example, —(S(O)₂O)X or —(S(O)₂O)X₂, wherein X is a monovalent or divalent cation). X may for instance be an alkali metal cation or a cationic alkaline earth metal. Thus, X may be Na⁺, K⁺, Ca²⁺ or Mg²⁺, for instance.

As used herein, the term “phosphate” represents a group of formula: —PO₄³⁻. As would be understood by the skilled person, a phosphate group can exist in protonated and deprotonated forms (for example, —PO₄H²⁻, —PO₄H₂⁻ or —PO₄³⁻), and in salt forms (for example, —(PO₄)X₃ or —(PO₄)₃X₂, wherein X is a monovalent or divalent cation). X may for instance be an alkali metal cation or a cationic alkaline earth metal. Thus, X may be Na⁺, K⁺, Ca²⁺ or Mg²⁺, for instance.

As used herein, the term “phosphonate” represents a group of formula: —PO(OR)₂⁻, wherein R is, for example, hydrogen or a C₁-C₆ alkyl group. As would be understood by the skilled person, a phosphonate group can exist in protonated and deprotonated forms (for example, —PO(OR)₂H of —PO(OR)₂⁻), and in salt forms (for example, —PO(OR)₂X or —PO(OR)X, wherein X is a monovalent or divalent cation). X may for instance be an alkali metal cation or a cationic alkaline earth metal. Thus, X may be Na⁺, K⁺, Ca²⁺ or Mg²⁺, for instance.

As used herein, the term “carboxyl” represents a group of the formula: —C(═O)O⁻, or —COO. As would be understood by the skilled person, a carboxyl group can exist in protonated and deprotonated forms (for example, —C(═O)OH and —C(═O)O⁻), and in salt forms (for example, —C(═O)OX or —(C(═O)O)₂X, wherein X is a monovalent or divalent cation). X may for instance be an alkali metal cation or a cationic alkaline earth metal. Thus, X may be Na⁺, K⁺, Ca²⁺ or Mg²⁺, for instance.

Typically, the anionic surfactant comprises an alkyl chain comprising from 5 to 35 carbon atoms, for instance, from 5 to 25 carbon atoms. Thus, the alkyl chain may be an unsubstituted or substituted C₅-C₃₅ alkyl group as defined herein. Usually, the anionic surfactant comprises an alkyl chain comprising from 5 to 20 carbon atoms (C₅-C₂₀ alkyl group), for instance, from 5 to 15 carbon atoms (C₅-C₁₅ alkyl group). For instance, the anionic surfactant may comprise an alkyl chain comprising from 8 to 15 carbon atoms (C₈-C₁₅ alkyl group). Typically, the alkyl group is unsubstituted. Thus, the surfactant may be a compound comprising an ionic functional group bonded to an unsubstituted C₅-C₃₅ alkyl group.

The anionic surfactant may further comprise a cation. The cation may be selected from a nitrogen-containing cation, e.g. ammonium, or a group I cation, e.g. sodium or potassium. In various embodiments, the anionic surfactant is selected from ammonium lauryl sulphate, dioctyl sodium sulfosuccinate, potassium lauryl sulfate, soap, sodium dodecyl sulphate (SDS), sodium dodecylbenzenesulphonate, sodium decyl sulfonate, sodium laureth sulphate, sodium lauroyl sarcosinate, sodium myreth sulphate, sodium pareth sulfate, and sodium stearate. The anionic surfactant may, for instance, be sodium dodecyl sulphate (SDS) or sodium dodecylbenzenesulphonate (SBDS).

In various embodiments the ionisable groups of the polymer are acidic and the precipitant is selected from a cationic surfactant, an anionic surfactant, a polymer with at least one basic group, and mixtures thereof. The cationic surfactant may comprise a cationic functional group and a C₅-C₃₅ alkyl group. In preferred embodiments, the cationic surfactant comprises a cationic functional group, and a C₅-C₂₀ alkyl group. The cationic functional group may comprise a quaternary nitrogen or may be a nitrogen-containing group wherein the nitrogen is not a quaternary nitrogen.

As used herein, a cationic nitrogen-containing group is a group wherein the nitrogens are not quaternary nitrogens, such as protonated monodentate primary, secondary and tertiary amino groups, i.e. —NH₃, —NHR₂, and —NH₂R, and protonated bidentate secondary and tertiary amines, i.e. —N⁺RH— and —NH₂—. As the skilled person will appreciate, the cationic nitrogen-containing groups will usually only be cationic if in acidic conditions (i.e. pH of less than 7).

When the cationic surfactant comprises a quaternary nitrogen, the quaternary nitrogen typically has the formula: (NR₁R₂R₃R₄)⁺, wherein R₁, R₂, R₃ and R₄ are independently selected from a substituted or unsubstituted alkyl group or a substituted or unsubstituted alkenyl group. Usually, when the cationic surfactant comprises a quaternary nitrogen, the quaternary nitrogen typically has the formula: (NR₁R₂R₃R₄)⁺, wherein R₁, R₂, R₃ and R₄ are independently selected from a substituted or unsubstituted C₁-C₃₀ alkyl group. In preferred embodiments, R₁, R₂ and R₃ are independently selected from a substituted or unsubstituted C₁-C₆ alkyl group and R₄ is a substituted or unsubstituted C₁₀-C₃₀ alkyl group. For instance, R₁, R₂ and R₃ are independently selected from a substituted or unsubstituted C₁-C₃ alkyl group such as methyl or ethyl, for instance methyl, and R₄ is a substituted or unsubstituted C₁₀-C₂₀ alkyl group, for instance R₄ a substituted or unsubstituted C₁₅-C₂₀ alkyl group.

The cationic surfactant may, for instance, comprise an anion, for instance a halide such as a fluoride, chloride, bromide or iodide anion. Typically, the anion is a chloride anion or a bromide anion.

The cationic surfactant may, for instance, be selected from a benzalkonium chloride, Myristyltrimethylammonium bromide (C₁₄TAB or MTAB) and Myristyltrimethylammonium chloride. The cationic surfactant may, for instance, be Myristyltrimethylammonium bromide (C₁₄TAB, or MTAB). In other embodiments the cationic surfactant may be 1-hexadecylpyridinium chloride.

When the polymer comprises a combination of acidic and basic groups, the precipitant may comprise an amphoteric surfactant. In various embodiments, the amphoteric surfactant is selected from the group consisting of hydrocarbyl-amphoacetates, alkenyl-amphoacetates, hydrocarbyl-amphodiacetates, alkenyl-amphodiacetates, hydrocarbylampho-propionates, hydrocarbylampho-diproprionates, hydrocarbylamphohydroxypropyl sultaines, and mixtures thereof. In various embodiments, the hydrocarbyl and alkenyl groups are C₆ to C₂₄, C₈ to C₂₄, or C₁₀ to C₂₀, hydrocarbyl or alkenyl groups. Typically, the amphoteric surfactant has a counter-ion of an alkali metal such as sodium or potassium, or an ammonium ion. In preferred embodiments, the amphoteric surfactant has an alkali metal counter-ion, and more preferably the counter-ion is sodium.

In various embodiments the amphoteric surfactant is a hydrocarbyl-amphoacetate salt, preferably a fatty acid amphoacetate. The fatty acid or salt thereof may be a C₆-C₂₄ fatty acid or salt thereof, or a mixture thereof. The fatty acid or salt thereof may be saturated or unsaturated. When unsaturated, the unsaturated fatty acid or salt thereof may be mono- or di-unsaturated. The unsaturated fatty acid or salt thereof may comprise cis- or trans-double bonds or mixtures thereof. In further embodiments, the fatty acid or salt thereof is a C₁₂-C₁₈ monounsaturated fatty acid or salt thereof. Examples of fatty acids include stearic acid, ricinoleic acid, oleic acid, eladic acid, petrolselinic acid, palmitic acid, erucic acid, behenic acid, lauric acid, myristic acid, or linoleic acid.

In preferred embodiments, the amphoteric surfactant comprises a cocoamphoacetate. The counter-ion of the cocoamphoacetate is preferably sodium. Sodium cocoamphoacetate is commercially available, for example under the trade name Dehyton® MC (BASF) or Amphosol® 1C (Stepan®). Such commercial preparations are typically solutions of sodium cocoamphoacetate, typically containing from about 30 to about 40 wt % sodium cocoamphoacetate on an actives basis.

### Separation of the Complex and Recovery of the Metal Species

In various embodiments, the process further comprises the step of (iii) separating the complex from the solution. The complex is as defined herein. Separation of the complex from the solution may be carried out using any suitable technique known in the art. For example, a separation method based on real or artificial gravity, adsorption, decantation, elutriation, filtration, magnetic separation, sedimentation, centrifugation, sieving, or a combination thereof. Absorption is a technique that is applied by introducing a new phase to absorb one or more components from the mixture that is encountered from the other phase; it can be physical absorption or chemical absorption. Adsorption is the adhesion of particles (e.g. particles in the complex, the metal species, the polymer comprising ionisable groups, or the precipitant) in solution to a surface, an example is adsorption onto carbon and flotation as defined below. Decantation is a process for the separation of mixtures, for example, by removing one or more liquid layers. Elutriation is a process for separating particles based on their size, shape and/or density. The process typically uses a stream of gas or liquid flowing in a direction usually opposite to the direction of sedimentation. Filtration is a process of separating solids from liquid using a medium that allows liquids to pass through it, but prevents solids of a certain size from passing through it. Magnetic separation is a process of using a magnetic force to remove a magnetically susceptible material. Sedimentation refers to the tendency for particles in suspension to settle out of a liquid. Centrifugation is a technique that uses centrifugal forces (using a centrifuge) and applies the principle of sedimentation by using the difference in density, shape and size to separate components from mixtures. Sieving is a process for separating solids from liquids using a sieve, i.e. a mesh or net capable of effectively trapping solid particles.

Generally, separating the complex from the solution depends on how the complex is present in the solution, i.e. as a suspension or other type of dispersion, and its particle size. In various embodiments, separating the complex from the solution comprises filtration, sedimentation, adsorption or a combination thereof. Filtration and sedimentation are defined above. Flotation is a process in which solids in suspension are recovered by their attachment to gas, usually air bubbles.

The step of separating the complex from the solution may comprise passing the solution through a filter, wherein the pore size of the filter is smaller than the size of the precipitate. The pore size may, for instance, be larger than the size of the metal species. Thus, typically, the precipitate will not be able to pass through the filter whereas any metal species that are not part of a precipitate will be able to pass through the filter. As used herein, the pore size is the average diameter of the pore. If, for example, the pore is not spherical, the diameter of an individual pore is the diameter of a circle having the same area as the pore.

The step of separating the complex from the solution may comprise passing the solution through a filter, wherein the filter has an average pore size of from 5 μm to 100 μm.

In various embodiments the process further comprises the step of (iv) removing the metal species from a composition comprising the complex. In the process of the present disclosure, removing the metal species from the composition comprises forming a salt of the metal species. The composition comprises a polymer-ligand-metal species-precipitant aggregate (i.e. complex (polymer-ligand-metal) and precipitant aggregate), where the metal species is bound to at least one or more groups of the ligand. The metal species may be further bound to the precipitant. Thus, the process of removing the metal species from said composition comprises removing the metal species from the aggregate. A representative aggregate is shown in FIG. 5.

The term “polymer-ligand-metal species-precipitant aggregate”, as used herein, refers to an aggregate of the polymer, ligand, metal species, and precipitant, i.e. complex+precipitant. The polymer, ligand, metal species, and precipitant are as defined for the process of the present disclosure. The composition comprising the complex of the present disclosure may therefore comprise the polymer-ligand-metal species-precipitant aggregate. The aggregate is a species in which the precipitant molecules are bound to the complex, for example the precipitant may be bound to the polymer, the ligand molecules are bound to the polymer, and the metal species are bound to the ligand, the metal species may further be bound to the precipitant. The nature of the interactions between these molecules is discussed elsewhere in the specification.

Generally, in the aggregate, multiple molecules of the precipitant are bound to any one molecule of the polymer. An aggregate may contain more than one molecule of the polymer, but each molecule of the polymer in the aggregate is itself bound to multiple precipitant molecules. Similarly, multiple molecules of the ligand are bound to any one molecule of the polymer and one or more, typically multiple, molecules of the ligand are bound to each metal species. Multiple precipitant molecules may also be bound to each metal species. Generally, the precipitant molecules that are bound to the polymer and metal species form micelle-type structures, and the surface of each micelle-like structure binds to the polymer and metal species. Typically, hydrophilic groups of the precipitant molecules form the surface of each micelle-like structure and hydrophobic groups of the precipitant molecules form the centre of each micelle-like structure. The polymer is typically a hydrophilic polymer. Typically, the hydrophilic surface of each micelle-like structure binds to the hydrophilic polymer, and typically there will be many micelle-like structures bound to one molecule of polymer. The same applies to the interaction of the precipitant surfactant with the metal species. The structure of an exemplary aggregate is shown in FIG. 5.

Thus, in the process of the present disclosure, treating the solution with the polymer, ligand and the precipitant typically results in the formation of an aggregate as defined above, and self-precipitation typically occurs, such that the precipitates loaded with the metal species will settle out or can be easily filtered or otherwise separated from the treated solution. In order to remove the metal species from the composition comprising the complex, in particular the composition comprising the aggregate, the process may involve the formation of a salt or the precipitates can be incinerated and the metallic ions recovered as concentrated metal oxides.

As the skilled person will appreciate, a salt is an ionic compound that may be formed when a positively charged species reacts with a negatively charged species to form an electrically neutral product. Typically, a salt is produced by the neutralization reaction between an acid and a base. Thus, the formation of a salt may require the pH of a solution to be adjusted (i.e. increased or decreased) to produce the desired result. Further, for the metal species to form a neutral species, the salt formation typically requires the presence of a suitable counter ion, e.g. when the metal species is a positively charged species the counter ion will be a negatively charged counter ion and when the metal species is a negatively charged species the counter ion will be a positively charged counter ion. The counter ion may be found in the solution or may be added to the solution as part of the process of salt formation.

Thus, forming a dissolved salt of the metal species optionally comprises adjusting the pH. When the metal species is a positively charged species, adjusting the pH comprises treating the composition with an acidic solution. Thus, adjusting the pH often comprises reducing the pH, preferably reducing the pH to a pH of less than or equal to about 5. As the skilled person will appreciate, the adjusted pH depends upon the metal species present.

The acid may for instance be selected from an inorganic acid, a sulfonic acid, a carboxylic acid and a halogenated carboxylic acid, or a combination thereof. The acid may, for instance, comprise an inorganic acid such as sulphuric acid (H₂SO₄). The sulphuric acid may, for instance, be a solution of sulphuric acid having a pH of approximately 1. Alternatively, in the process of the present disclosure, removing the metal species from the composition may comprise treating the composition with an amine solution.

In other embodiments, the metal species are negatively charged species and adjusting the pH comprises treating the composition with an alkaline solution. Thus, the process may comprise treating the composition with a base. Suitable bases include hydroxides such as sodium hydroxide (NaOH), potassium hydroxide (KOH), ammonium hydroxide (NH₄OH), calcium hydroxide (Ca(OH)₂), magnesium hydroxide (Mg(OH)₂), barium hydroxide (Ba(OH)₂), aluminium hydroxide (Al(OH)₃), iron (ii) hydroxide (Fe(OH)₂), iron (iii) hydroxide (Fe(OH)₃), zinc hydroxide (Zn(OH)₂) and lithium hydroxide (LiOH). The base may, for example, be sodium hydroxide or potassium hydroxide, for instance, potassium hydroxide.

Typically, the process further comprises separating the salt of the metal species from the polymer, ligand and precipitant. The step of separating the salt from the polymer, ligand and the precipitant may comprise a process of separation selected from adsorption, decantation, elutriation, filtration, magnetic separation, sedimentation and sieving, or a combination thereof. The process of separation may, for instance, be filtration or sedimentation, or a combination thereof. Usually, a concentrated salt is formed, followed by filtration/settling to separate this from the remaining polymer-ligand-precipitant solid. Thus, preferably, separating the salt from the polymer, ligand and precipitant comprises filtration, optionally wherein separating the salt from the polymer, ligand and precipitant comprises filtering a composition comprising (i) a solution of the salt of the metal species, and (ii) a precipitate comprising the polymer, ligand and the precipitant.

Filtering the composition may for example comprise using a filter having an average pore size of from 5 μm to 100 μm.

Removing the metal species from the composition may comprise heating the composition and recovery of the metal species in the form of an oxide comprising the metal species. Typically, heating the composition comprises incineration of the composition. Typically, the heating also causes sublimation of the resulting metal oxide. The metal species is typically then recovered in the form of a solid oxide comprising the metal species.

After the step of removing the metal species from the composition, the process of the present disclosure may further comprise recovering the polymer, ligand and/or the precipitant. Typically, recovering the polymer, ligand and/or the precipitant comprises adjusting the pH of a composition comprising the polymer, ligand and precipitant.

In some embodiments, the metal species are positively charged species, and the step of recovering the polymer, ligand and/or the precipitant comprises treating the composition comprising the polymer, ligand and/or the precipitant with a base or an alkaline solution. Thus, the step of recovering the polymer, ligand and/or the precipitant comprises increasing the pH. Suitable bases for increasing the pH of the solution are outlined above.

In some embodiments, the metal species are negatively charged species, and the step of recovering the polymer, ligand and/or the precipitant comprises treating the composition comprising the polymer, ligand and/or the precipitant with an acid, for instance with an acidic solution. The step of recovering the polymer, ligand and/or the precipitant may, therefore, comprise decreasing the pH of the solution. The acid may comprise an inorganic acid (for instance sulfuric acid), a sulfonic acid, a carboxylic acid or a halogenated carboxylic acid.

After the step of recovering the polymer, ligand and/or the precipitant, the recovered polymer, ligand and/or the precipitant may, for instance, be used in another process, i.e. the recovered polymer, ligand and/or the precipitant may be recycled. In one embodiment, the process of the present disclosure comprises re-using the recovered polymer, ligand and/or the precipitant in a further cycle of the process of the disclosure. The further cycle of the process may be a process as further defined anywhere herein.

### Uses

A further aspect of the present disclosure is the use of a polymer comprising ionisable groups, a ligand, and a precipitant, to remove a metal species from a solution. The solution comprises the metal species and a solvent as defined herein. The ionisable groups of the polymer are basic and the ligand comprises at least one acidic group, or the ionisable groups of the polymer are acidic and the ligand comprises at least one basic group, the polymer and ligand being defined herein. The ligand further comprises at least one group that binds the metal species. The precipitant comprises at least one group that binds the metal species and/or the polymer as defined herein, and further comprises at least one hydrophobic moiety.

A further aspect of the present disclosure is the use of a salt to remove a metal species from a solution, wherein the solution comprises the metal species and a solvent as defined herein. The salt comprises (a) a cation of a polymer comprising basic ionisable groups and an anion of a ligand comprising at least one acidic group, or (b) an anion of a polymer comprising acidic ionisable groups and a cation of a ligand comprising at least one basic group, the polymer and ligand are as defined herein. The ligand comprises at least one group capable of binding the metal species.

The features disclosed above for the process, complex or salt of the present disclosure apply equally to the uses of the present disclosure. In various embodiments, for example, the molar ratio of the monomer units of the polymer to the ligand is from about 1:4 to about 8:1.

### Embodiments

In various embodiments, the metal species is selected from platinum group, gold and silver metal species; the ionisable groups of the polymer are basic N-containing groups; the ligand comprises a C₁₋₁₂ alkyl, and: (i) at least one carboxyl group or sulfonic acid group and (ii) at least one thiol, thioether, thioester, thioamide, phosphonate, dithiocarbamate, thionyl, amine, or a combination thereof; preferably wherein the ligand has the formula:

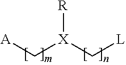

wherein n is 0 to 5; m is 1 to 5; L is a carboxyl group or an amine; A is selected from thiol, thioether, thioester, thioamide, dithiocarbamate, thionyl, phosphonate and amine; X is C or N; and R is selected from hydrogen, C₁₋₅ alkyl, thiol, thioether, thioester, thioamide, dithiocarbamate, thienyl, and amine, provided that when X is N, R is hydrogen or C₁₋₅ alkyl; or the ligand comprises a N-heterocycle containing 1 to 5 carbon atoms and at least one thiol, thioether, thioester, thioamide, dithiocarbamate, thionyl, alcohol, ester, ketone, carboxylic acid, or a combination thereof; and the precipitant is selected from an anionic surfactant, a cationic surfactant, and mixtures thereof.

In preferred embodiments, A is a phosphonate group, X is C or N, and R is hydrogen.

In preferred embodiments L is a carboxyl group, A is selected from thiol, thioether, thioester, thioamide, dithiocarbamate, thionyl, and amine; X is C, and R is hydrogen.

In preferred embodiments the ligand comprises a N-heterocycle containing 1 to 5 carbon atoms and at least one thiol or carboxylic acid group.

In various embodiments, the metal species is a copper species, and the ionisable groups of the polymer are basic N-containing groups, or acidic S-containing groups; the ligand comprises a C₁-C₁₂ alkyl and: (i) at least one carboxyl group, sulfonic acid or phosphonate group, and (ii) at least one thiol, thioether, thioester, thioamide, dithiocarbamate, thionyl, amine, or a combination thereof, preferably wherein the ligand has the formula:

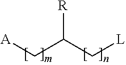

wherein n is 0 to 5; m is 1 to 5; L is a carboxyl group or an amine; A is selected from thiol, thioether, thioester, thioamide, dithiocarbamate, thionyl, and phosphonate; and R is selected from hydrogen, thiol, thioether, thioester, thioamide, dithiocarbamate, and thionyl; or the ligand comprises a N-heterocycle containing 1 to 5 carbon atoms and at least one thiol, thioether, thioester, thioamide, dithiocarbamate, thionyl, or a combination thereof; and the precipitant is selected from an anionic surfactant, a cationic surfactant, a polymer with ionisable groups, the ionisable groups being of opposite charge to the basic N-containing groups or acidic S-containing groups of the polymer with ionisable groups, and mixtures thereof.

In preferred embodiments, A is a phosphonate group, L is amine, and R is hydrogen.

In preferred embodiments L is a carboxyl group, A is selected from thiol, thioether, thioester, thioamide, dithiocarbamate, thionyl, and amine; X is C, and R is hydrogen.

In preferred embodiments the ligand comprises a N-heterocycle containing 1 to 5 carbon atoms and at least one thiol or carboxylic acid group.

The aspects of the present disclosure will be further described in the following Examples.

### EXAMPLES

### Introduction

The process of the present disclosure is a novel process for the removal and recovery of valuable metal species from aqueous streams. Advantageously the process facilitates bulk removal of noble and/or rare earth metals from aqueous waste effluents. The process uses polymers having ionisable groups, and ligands, as defined herein, to form a complex with the metal species. The ionisable groups of the polymer are acidic or basic, for example N-containing when basic and carboxyl group-containing when acidic. The ligand has corresponding basic or acidic groups, said corresponding basic or acidic groups being electrostatically bound to the polymer. The precipitant has a hydrophobic moiety and a group that binds to the metal species and/or polymer to form a self-removable species. The complex coordinates the metal species (ions) from the solution and precipitates out for separation and recovery of the metal species therein. Separation may be by filtering the aqueous stream, and the targeted metal species in the separated products may be recovered by acidification and concentration, or incinerated and the metallic ions recovered as concentrated metal oxides.

### Summary of Experimental Work and Results

In this Example of the present disclosure, a water-soluble polymer-ligand mixture was used with a precipitant and a palladium-containing waste solution, to prepare a polymer-ligand-metal complex and complex-precipitant aggregate to thereby recover palladium from the solution. The palladium-containing solution was aqueous and contained less than 10 wt % organics. The conditions for recovery were found to be ideally basic (pH>7) in view of the polymer and ligand employed in this Example but the present disclosure is not limited in this respect. After addition of the polymer and ligand, the palladium-containing solution was adjusted to an acidic pH (pH<7), charged with the precipitant (here a surfactant), and a solid was precipitated. The solid was collected via a recirculating filtration and the Pd recovery quantified by comparing the initial Pd concentration with the liquor Pd concentration. Such concentrations were measured by ICP-OES (Inductively Coupled Plasma Optical Emission Spectroscopy), as is known in the art.

The complex of the present disclosure was found to improve the palladium recovery yield in a shorter timeframe compared to ion exchange. This is advantageous for industrial application and scale-up of the inventive process.

### Further Examples 1

Further experiments were conducted in support of the above introductory paragraph.

### Materials and Methods

| Ref | Metal | Concentration [ppm] | Metal Salt |
|---|---|---|---|
| Po | Palladium | 1000/200 | PdCl₂ |
| Cu | Copper | 1000 | CuCl₂ |
| Pt | Platinum | 200 | PtCl₄ |
| Au | Gold | 200 | HAuCl₄•3H₂O |
| Rh | Rhodium | 200 | RhCl₃ |
| Ir | Iridium | 200 | IrCl₃ |
| Mix | Pd/Pt/Au/Rh/Ir | 40 per metal | Same as above |

| Ref | Polymer Name | Monomer Structure |
|---|---|---|
| PEI | Polyethyleneimine (25 kDa) | 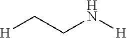 |
| CHT | Chitosan (200-800 cps) | 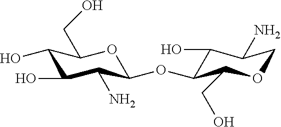 |
| PSF | Polystyrene sulfonic acid (75 kDa) | 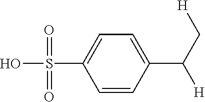 [SMILES: CCc1ccc(S(=O)(=O)O)cc1] |
| PAA | Polyallylamine (15 kDa) | 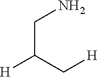 |

| Ref | Ligand Name | Ligand Structure |
|---|---|---|
| 1 | Picolinic acid | 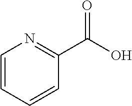 |
| 2 | Thioglycolic acid | 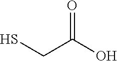 |
| 3 | Glycine | 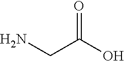 |
| 4 | L-Cysteine | 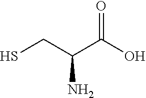 |
| 5 | Trimercaptotriazine | 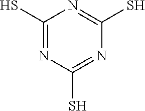 |

| Ref | Precipitant Name | Precipitant Structure |
|---|---|---|
| SDS | Sodium dodecyl sulfate | 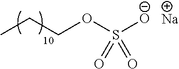 |
| SBDS | Dodecylbenzene sulfonic acid sodium salt | 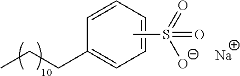 |
| HPDC | 1-Hexadecylpyridinium chloride hydrate | 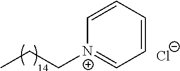 |
| PSF | Polystyrene sulfonic acid (75 kDa) | 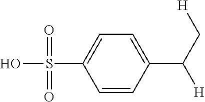 [SMILES: CCc1ccc(S(=O)(=O)O)cc1] |
| SDF | Sodium decyl sulfonate | 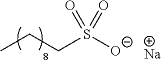 |

All metal salts, polymers, ligands, and precipitants were obtained from commercial sources and used without further purification. Metal salts were used as aqueous solutions at the specified concentrations. All polymers, ligands, and surfactants were used as 10% wt aqueous solutions (except chitosan, which was charged as a solid). Each metal recovery experiment was conducted at 5 g scale, typically with addition of 1 g of 25 wt % NaCl solution and charged with 10 molar equivalents of ligand solution and mixed for ca. 2 to 8 h, without pH adjustment. After mixing, each mixture was charged with 15 molar equivalents of polymer solution and mixed for ca. 16 to 24 h. After mixing with polymer solution, each mixture was charged with the specified precipitant and aged for ca. 1 to 3 h without pH adjustment, then assessed for precipitation. In instances where precipitation was not observed, the pH was adjusted from acidic to basic, or vice versa, aged for a further hour, then reassessed for precipitation. Solids were separated by centrifugation and all samples were analysed by ICP-OES, Perkin-Elmer Avio 220 Max. All ICP-OES samples were prepared via microwave digestion, Anton Paar Multiwave 5000, digesting in either conc. nitric acid or aqua regia. After digestion samples were diluted to a known volume in a matrix of either 2% nitric or hydrochloric acid and ran with a 1 ppm yttrium internal standard.

### Results

TABLE 1

| Exp Ref | Metal | Polymer | Ligand | Precipitant | Recovery (% th) |
|---|---|---|---|---|---|
| 1-A1 | Pd | PEI | 1 | SDS | 86 |
| 1-A2 | | | 2 | SDS | 97 |
| 1-A3 | | | 3 | SDS | >98 |
| 1-A4 | | | 4 | SDS | 3 |
| 1-A5 | | | 5 | SDS | 96 |
| 1-B1 | | CHT | 1 | SDS | >98 |
| 1-B2 | | | 2 | SDS | 55 |
| 1-B3 | | | 3 | SDS | 93 |
| 1-B4 | | | 4 | SDS | 90 |
| 1-B5 | | | 5 | SDS | >98 |
| 1-C1 | | PSF | 1 | SDS | 45 |
| 1-C2 | | | 2 | SDS | N.D. |
| 1-C3 | | | 3 | SDS | N.D. |
| 1-C4 | | | 4 | SDS | 11 |
| 1-C5 | | | 5 | SDS | 87 |
| 1-D1 | | PAA | 1 | SDS | 97 |
| 1-D2 | | | 2 | SDS | 90 |
| 1-D3 | | | 3 | SDS | 78 |
| 1-D4 | | | 4 | SDS | N.D. |
| 1-D5 | | | 5 | SDS | 97 |

TABLE 2

| Exp Ref | Metal | Polymer | Ligand | Precipitant | Recovery (% th) |
|---|---|---|---|---|---|
| 2-A1 | Cu | PEI | 1 | SDS | 40 |
| 2-A2 | | | 2 | SDS | 90 |
| 2-A3 | | | 3 | SDS | 91 |
| 2-A4 | | | 4 | SDS | 85 |
| 2-A5 | | | 5 | SDS | >98 |
| 2-B1 | | CHT | 1 | SDS | 75 |
| 2-B2 | | | 2 | SDS | >98 |
| 2-B3 | | | 3 | SDS | 52 |
| 2-B4 | | | 4 | SDS | >98 |
| 2-B5 | | | 5 | SDS | >98 |
| 2-C1 | | PSF | 1 | SDS | 66 |
| 2-C2 | | | 2 | SDS | >98 |
| 2-C3 | | | 3 | SDS | 9 |
| 2-C4 | | | 4 | SDS | >98 |
| 2-C5 | | | 5 | SDS | >98 |
| 2-D1 | | PAA | 1 | SDS | 73 |
| 2-D2 | | | 2 | SDS | >98 |
| 2-D3 | | | 3 | SDS | 6 |
| 2-D4 | | | 4 | SDS | >98 |
| 2-D5 | | | 5 | SDS | >98 |

TABLE 3

| Exp Ref | Metal | Polymer | Ligand | Precipitant | Recovery (% th) |
|---|---|---|---|---|---|
| 3-A1 | Pd | PEI | 1 | SBDS | 90 |
| 3-A2 | | | 3 | | 98 |
| 3-A3 | | | 5 | | 90 |
| 3-B1 | | | 1 | HPDC | 96 |
| 3-B2 | | | 3 | | >98 |
| 3-B3 | | | 5 | | >98 |
| 3-C1 | | | 1 | PSF | 9 |
| 3-C2 | | | 3 | | 6 |
| 3-C3 | | | 5 | | 47 |
| 3-D1 | | | 1 | SDF | 63 |
| 3-D2 | | | 3 | | 54 |
| 3-D3 | | | 5 | | 97 |
| 3-A4 | Cu | | 1 | SBDS | 51 |
| 3-A5 | | | 3 | | 86 |
| 3-A6 | | | 5 | | 97 |
| 3-B4 | | | 1 | HPDC | 51 |
| 3-B5 | | | 3 | | 91 |
| 3-B6 | | | 5 | | 94 |
| 3-C4 | | | 1 | PSF | 49 |
| 3-C5 | | | 3 | | 10 |
| 3-C6 | | | 5 | | 93 |
| 3-D4 | | | 1 | SDF | 57 |
| 3-D5 | | | 3 | | 45 |
| 3-D6 | | | 5 | | 95 |

TABLE 4

| Condition Ref | Polymer | Ligand | Precipitant |
|---|---|---|---|
| A | PEI | 3 | SBDS |
| B | PEI | 5 | SBDS |
| C | PEI | 2 | SBDS |
| D | PSF | 2 | PEI |

TABLE 5

| Exp Ref | Metal | Conditions (see Table 4) | Recovery (% th) |
|---|---|---|---|
| 4-A1 | Pd | A | >98 |
| 4-B1 | | B | >98 |
| 4-C1 | | C | 94 |
| 4-D1 | | D | 6 |
| 4-A2 | Pt | A | 93 |
| 4-B2 | | B | >98 |
| 4-C2 | | C | >98 |
| 4-D2 | | D | 62 |
| 4-A3 | Rh | A | >98 |
| 4-B3 | | B | >98 |
| 4-C3 | | C | 53 |
| 4-D3 | | D | 91 |
| 4-A4 | Au | A | 96 |
| 4-B4 | | B | >98 |
| 4-C4 | | C | >98 |
| 4-D4 | | D | 38 |
| 4-A5 | Ir | A | 91 |
| 4-B5 | | B | 73 |
| 4-C5 | | C | 78 |
| 4-D5 | | D | 17 |

TABLE 6

| | | Conditions | | | | | |
|---|---|---|---|---|---|---|---|
| | | (see Table | Recovery (% th) | | | | |
| Exp Ref | Metal | 4) | Pd | Pt | Au | Rh | Ir |
| 4-A6 | Mix | A | 65 | 97 | 96 | 97 | 83 |
| 4-B6 | | B | 92 | 88 | 90 | 95 | 73 |
| 4-C6 | | C | 96 | 98 | 92 | 57 | 79 |
| 4-D6 | | D | 64 | 80 | 9 | 78 | 78 |

### Conclusions

The experiments detailed in the tables above show a varied recovery of metal species ranging from N.D. (not detected) (<2% th recovery) to >98% th recovery. The recovery efficiency is associated with the combination of polymer-ligand-precipitant selected for the metal species, which combination and choice thereof is supported by the disclosure herein. This is advantageous because it means the person skilled in the art has control over the metal species recovery. The experiments also demonstrate the ability to recover multiple metal species from a single solution, as well as the ability to recover metal species at “high” concentrations, i.e. greater than 100 ppm.

For example, experiments 1-A3 and 1-A4 show how glycine (Ligand 3) allows for >98% th recovery of palladium using a basic polymer (e.g. PEI) and an anionic surfactant (e.g. SDS) precipitant whereas L-cysteine (Ligand 4) results in 3% th Pd recovery. This is believed to be due to a difference in binding of the metal to the ligand under the solution conditions and/or a difference in binding of the metal-ligand species to the polymer. This does not, however, prevent the skilled person from working the described process. To the contrary, it can be seen from Table 1 that a facile change of ligand resulted in efficient Pd recovery. A similar trend is observed between experiments 1-D3 and 1-D4. Another example is found for copper recovery with experiments 2-C₃ and 2-C₄. Ligand 3 (glycine) resulted in 9% th recovery of copper when used with PSF as the polymer and SDS as the precipitant, whereas Ligand 4 (L-cysteine) resulted in >98% th recovery.

As shown by the experiments above, to achieve a high metal recovery from solution (including recovery of multiple and different metal species from a single solution), a polymer-ligand-precipitant system should be chosen which is compatible with both the target metal species and solution conditions. A person skilled in the art would recognise that in some cases it may be preferable to modify the polymer-ligand-precipitant selection and in some cases, it may be preferable to modify the solution conditions, e.g. adjusting the pH via the addition of an acid or base. Such modifications are within the scope of the present disclosure. As noted above, for example, it may be beneficial to monitor the pH during formation of the complex and/or during precipitation and adjust to promote salt formation and/or binding of the precipitant to the metal species and/or polymer.

### Further Examples 2

Further experiments were conducted in support of ligands having phosphorus-containing groups.

### Materials and Methods

| Ref | Metal | Concentration [ppm] | Metal Salt |
|---|---|---|---|
| Pd | Palladium | 1000/200 | PdCl₂ |
| Cu | Copper | 1000 | CuCl₂ |
| Pt | Platinum | 200 | PtCl₄ |
| Au | Gold | 200 | HAuCl₄•3H₂O |
| Rh | Rhodium | 200 | RhCl₃ |
| Ir | Iridium | 200 | IrCl₃ |
| Mix | Pd/Pt/Au/Rh/Ir | 40 for each metal | Same as above |

| Ref | Polymer Name | Monomer Structure |
|---|---|---|
| PEI | Polyethyleneimine (25 kDa) | 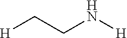 |
| PSF | Polystyrene sulfonic acid (75 kDa) | 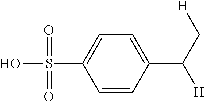 [SMILES: CCc1ccc(S(=O)(=O)O)cc1] |

| Ref | Ligand Name | Ligand Structure |
|---|---|---|
| 6 | Glyphosate (N-(phosphonomethyl)glycine) | 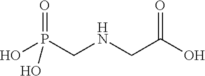 |
| 7 | 2-Aminoethyl phosphonic acid | 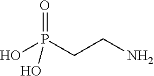 |

| Ref | Precipitant Name | Precipitant Structure |
|---|---|---|
| SBDS | Dodecylbenzene sulfonic acid sodium salt | 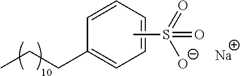 |
| HPDC | 1-Hexadecylpyridinium chloride hydrate | 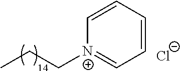 |

All metal salts, polymers, ligands, and precipitants were obtained from commercial sources and used without further purification. Metal salts were used as aqueous solutions at the specified concentrations. All polymers, ligands, and surfactants were used as 10% wt aqueous solutions. Each metal recovery experiment was conducted at 5 g scale, typically with addition of 1 g of 25 wt % NaCl solution and charged with 10 molar equivalents of ligand solution and mixed for ca. 2 to 8 h, without pH adjustment. After mixing each mixture was charged with 15 molar equivalents of polymer solution and mixed for ca. 16 to 24 h. After mixing with polymer solution each mixture was charged with the specified precipitant and aged for ca. 1 to 3 h without pH adjustment, then assessed for precipitation. In instances where precipitation was not observed, the pH was adjusted from acidic to basic, or vice versa, aged for a further hour, then reassessed for precipitation. Solids were separated by centrifugation and all samples were analysed by ICP-OES, Perkin-Elmer Avio 220 Max. All ICP-OES samples were prepared via microwave digestion, Anton Paar Multiwave 5000, digesting in either conc. nitric acid or aqua regia. After digestion samples were diluted to a known volume in a matrix of either 2% nitric or hydrochloric acid and ran with a 1 ppm yttrium internal standard.

### Results

TABLE 7

| Condition Ref | Polymer | Ligand | Precipitant |
|---|---|---|---|
| F | PEI | 6 | SBDS |
| G | PEI | 7 | SBDS |
| H | PSF | 6 | PEI |
| I | PEI | 6 | HPDC |

TABLE 8

| Exp Ref | Metal | Conditions | Recovery (% th) |
|---|---|---|---|
| 5-A1 | Pd | F | >98 |
| 5-A2 | | G | >98 |
| 5-A3 | | H | 67 |
| 5-A4 | | I | 6 |
| 5-B1 | Cu | F | 15 |
| 5-B2 | | G | >98 |
| 5-B3 | | H | 9 |
| 5-B4 | | I | 7 |

### Conclusions

The experiments detailed in the tables above show the same trends as those in Further Examples 1. In particular, a varied recovery of metal species was observed with the recovery efficiency being associated with the combination of polymer-ligand-precipitant selected for the metal species, which combination and choice thereof is supported by the disclosure herein. For example, >98% th recovery of palladium was achieved with PEI as the polymer, SBDS as the precipitant and either of the ligands 6 or 7 (experiments 5-A1, 5-A2), whereas 6% th recovery of palladium was achieved with PEI as the polymer, HPDC as the precipitant and ligand 6 (experiment 5-A4). Copper recovery was >98% th with PEI as the polymer, ligand 7 and SBDS as the precipitant (experiment 5-B2).

The invention will be described in further detail in the following numbered clauses.

### NUMBERED CLAUSES

1. A process for removing a metal species from a solution, wherein the solution comprises the metal species and a solvent, which process comprises treating the solution with a polymer comprising ionisable groups, and a ligand, to form a complex; and treating the solution with a precipitant;
   wherein the ionisable groups of the polymer are basic and the ligand comprises at least one acidic group, or wherein the ionisable groups of the polymer are acidic and the ligand comprises at least one basic group;
   wherein the ligand comprises at least one group that binds the metal species;
   and wherein the precipitant comprises at least one group that binds the metal species and/or the polymer, and at least one hydrophobic moiety.
2. The process of clause 1, wherein the ligand electrostatically binds the polymer.
3. The process of clause 1 or clause 2, wherein the complex comprises:
   a positively charged species formed from the polymer and a negatively charged species formed from the ligand, or a negatively charged species formed from the polymer and a positively charged species formed from the ligand; and
   the metal species.
4. The process according to any preceding clause, wherein the process comprises:
   mixing the polymer with the ligand to form a salt; wherein the salt comprises a positively charged species formed from the polymer and a negatively charged species formed from the ligand, or a negatively charged species formed from the polymer and a positively charged species formed from the ligand;
   or wherein the process comprises:
   (i) mixing the polymer with the ligand to form a salt; wherein the salt comprises a positively charged species formed from the polymer and a negatively charged species formed from the ligand, or a negatively charged species formed from the polymer and a positively charged species formed from the ligand; and
   (ii) treating the solution comprising the metal species and the solvent with the salt formed in step (i) to form the complex as defined in clause 1, and treating the solution with the precipitant.
5. The process according to clause 4, wherein the salt is in the liquid phase, preferably wherein said liquid phase salt is an aqueous salt solution.
6. The process according to any preceding clause, wherein treating with the precipitant causes the complex to precipitate from the solution.
7. The process according to any preceding clause, wherein the process further comprises the step of:
   (iii) separating the complex from the solution.
8. The process according to clause 7, wherein separating the complex from the solution comprises filtration, sedimentation, flotation, or a combination thereof.
9. The process according to any preceding clause, wherein the process further comprises the step of:
   (iv) removing the metal species from a composition comprising the complex.
10. The process according to clause 8, wherein removing the metal species from the composition comprises forming a salt of the metal species, optionally wherein forming the salt of the metal species comprises adjusting the pH.
11. The process according to clause 10, wherein the process further comprises separating the salt of the metal species from the polymer, ligand, and precipitant; optionally wherein separating the salt of the metal species from the polymer, ligand, and precipitant comprises filtering a composition comprising (i) a solution of the salt of the metal species, and (ii) a precipitate comprising the polymer, ligand, and/or precipitant.
12. The process according to any of clauses 9 to 11, wherein the process further comprises, after step (iv), recovering the polymer, ligand, and/or precipitant; optionally wherein recovering the polymer, ligand, and/or precipitant comprises adjusting the pH of a composition comprising the polymer, ligand, and/or precipitant.
13. The process according to any preceding clause, wherein the metal species is selected from noble metal species; preferably wherein the metal species is selected from platinum group metal species, copper species, gold species, silver species, or a combination thereof; more preferably wherein the metal species is selected from platinum group metal species, gold species, silver species, or a combination thereof.
14. The process according to clause 13, wherein the metal species is a platinum group metal species.
15. The process according to any preceding clause, wherein the metal species is a metallic ion, preferably a metallic cation.
16. The process according to any preceding clause, wherein the concentration of the metal species to be removed in the solution is less than or equal to about 50 000 ppm.
17. The process according to any preceding clause, wherein the solution comprises a plurality of metal species and the plurality of metal species comprises a first metal species and at least one further metal species that is different from the first metal species and wherein the process is for removing at least the first metal species from the plurality of metal species in the solution.
18. The process according to any preceding clause, wherein the solvent is aqueous.
19. The process according to any preceding clause, wherein the ionisable groups of the polymer are basic and the ligand comprises at least one acidic group.
20. The process according to clause 19, wherein the ionisable groups of the polymer are N-containing groups, preferably wherein the ionisable groups of the polymer are amine groups.
21. The process according to clause 20, wherein the ionisable groups of the polymer are aliphatic amine groups.
22. The process according to any one of clauses 19 to 21, wherein the polymer comprises polyethyleneimine, polyvinylamine, polyallylamine, chitosan, polylysine, polyarginine, or a combination thereof, preferably wherein the polymer comprises polyethyleneimine, polyvinylamine, polyallylamine, or a combination thereof.
23. The process according to any one of clauses 19 to 22, wherein the at least one acidic group of the ligand is selected from carbon-based acids, sulfur-based acids, phosphorus-based acids, or a combination thereof, preferably wherein the at least one acidic group of the ligand is selected from a carboxyl group, a sulfonic acid group, a phosphoric acid group, a phosphinic acid group, and a phosphonic acid group; more preferably wherein the at least one acidic group is a carboxyl group or a sulfonic acid group.
24. The process according to any one of clauses 1 to 18, wherein the ionisable groups of the polymer are acidic and the ligand comprises at least one basic group.
25. The process according to clause 24, wherein the ionisable groups of the polymer are selected from carboxyl groups, sulfonic acid groups, phosphoric acid groups, phosphinic acid groups, phosphonic acid groups, or a combination thereof, preferably wherein the ionisable groups of the polymer are selected from carboxyl groups and sulfonic acid groups.
26. The process according to clause 24 or clause 25, wherein the polymer comprises monomeric units which are aliphatic hydrocarbons, and wherein the ionisable groups are carboxyl groups or sulfonic acid groups, preferably wherein the polymer comprises poly(meth)acrylic acid, polyaspartic acid, polyglutamic acid, alginic acid, polyvinylsulfonic acid, polyphosphoric acid, or a combination thereof.
27. The process according to any one of clauses 24 to 26, wherein the at least one basic group of the ligand is a N-containing group, preferably a N-containing group selected from amines, imines, N-heterocycles, and combinations thereof.
28. The process according to any preceding clause, wherein the at least one group that binds the metal species comprises at least one sulfur atom, phosphorus atom, nitrogen atom, oxygen atom, or a combination thereof.
29. The process according to clause 28, wherein the at least one group that binds the metal species comprises at least one thiol, thioether, thioester, thioamide, dithiocarbamate, thionyl, phosphine, phosphite, amine, imine, amide, N-heterocycle, alcohol, ether, ester, ketone, carboxylic acid, or a combination thereof.
30. The process according to any preceding clause, wherein the ligand is a C₁-C₁₂ hydrocarbyl comprising: (i) at least one carboxyl group, sulfonic acid group, phosphonic acid group, phosphoric acid group, phosphinic acid group, or a combination thereof; and (ii) at least one thiol, thioether, thioester, thioamide, dithiocarbamate, thionyl, phosphine, phosphite, amine, imine, amide, pyridine, alcohol, ether, ester, ketone, carboxylic acid, or a combination thereof.
31. The process according to clause 30, wherein the ligand is a C₁-C₁₂ alkyl, aryl, alkaryl, cycloalkyl, heteroaryl, or heteroalkaryl comprising: (i) at least one carboxyl group, sulfonic acid group, phosphonic acid group, phosphoric acid group, phosphinic acid group, or a combination thereof; and (ii) at least one thiol, thioether, thioester, thioamide, dithiocarbamate, thionyl, phosphine, phosphite, amine, imine, amide, pyridine, alcohol, ether, ester, ketone, carboxylic acid, or a combination thereof.
32. The process according to clause 31, wherein the ligand is a C₁-C₁₂ alkyl comprising: (i) at least one carboxyl group and (ii) at least one thiol, thioether, thioamide, dithiocarbamate, alcohol, amine, or a combination thereof.
33. The process according to clause 32, wherein the ligand is a C₁-C₄ alkyl substituted with: (i) at least one carboxyl group and (ii) at least one thiol, thioamide and/or thiourea group.
34. The process according to any preceding clause, wherein the ligand is a C₂-C₄ mercaptocarboxylic acid.
35. The process according to any of clauses 1 to 29, wherein the ligand is a C₁-C₁₂ hydrocarbyl and comprises at least one amine group and at least one thioyl group; at least two amine groups; at least two carboxylic acids; or at least one carboxylic acid and at least one thiol, thioether, thioamide, thioester, dithiocarbamate or thionyl group.
36. The process according to clause 35, wherein the ligand is a C₁-C₁₂ alkyl and comprises at least one amine group and at least one thioyl group; at least two amine groups; at least two carboxylic acids; or at least one carboxylic acid and at least one thiol, thioether, thioamide, thioester, dithiocarbamate or thionyl group.
37. The process according to any preceding clause, wherein the precipitant is a surfactant or a polymer with ionisable groups, the ionisable groups being of opposite charge to the complex-forming polymer with ionisable groups defined in clause 1.
38. The process according to any preceding clause, wherein the precipitant is selected from anionic, amphoteric or cationic surfactants, and mixtures thereof, preferably wherein the precipitant is selected from anionic surfactants, cationic surfactants, and mixtures thereof.
39. The process according to clause 38, wherein the ionisable groups of the polymer are basic and the precipitant is selected from an anionic surfactant and mixtures thereof.
40. The process according to clause 38 or clause 39, wherein the anionic surfactant comprises: an anionic functional group selected from a sulfate, sulfonate, phosphate, phosphonate and carboxylate group; and an alkyl chain comprising from 5 to 20 carbon atoms; preferably wherein the anionic surfactant is a C₅-C₂₀ alkyl sulfate.
41. The process according to clause 39, wherein the ionisable groups of the polymer are acidic and the precipitant is selected from a cationic surfactant and mixtures thereof.
42. The process according to clause 41, wherein the cationic surfactant comprises (a) a cationic functional group comprising a quaternary nitrogen having the formula: (NR¹R²R³R⁴)⁺, wherein R¹, R², R³ and R⁴ are independently selected from substituted or unsubstituted C₁-C₃₀ alkyl; or (b) a cationic nitrogen-containing group wherein the nitrogen is not a quaternary nitrogen.
43. The process according to any preceding clause, wherein:
   the metal species is selected from platinum group metal species;
   the ionisable groups of the polymer are N-containing groups;
   the ligand is a C₁-C₁₂ alkyl comprising: (i) at least one carboxyl group or sulfonic acid group and (ii) at least one thiol, thioether, thioamide, dithiocarbamate, thionyl, amine, or a combination thereof; and
   the precipitant is selected from an anionic surfactant and mixtures thereof.
44. Use of a polymer comprising ionisable groups, a ligand, and a precipitant, to remove a metal species from a solution,
   wherein the solution comprises the metal species and a solvent;
   wherein the ionisable groups of the polymer are basic and the ligand comprises at least one acidic group, or wherein the ionisable groups of the polymer are acidic and the ligand comprises at least one basic group;
   wherein the ligand comprises at least one group that binds the metal species; and
   wherein the precipitant comprises at least one group that binds the metal species and/or the polymer and further comprises at least one hydrophobic moiety.
45. Use of a salt to remove a metal species from a solution, wherein the solution comprises the metal species and a solvent, wherein the salt comprises:
   (a) a cation of a polymer comprising basic ionisable groups and an anion of a ligand comprising at least one acidic group; or
   (b) an anion of a polymer comprising acidic ionisable groups and a cation of a ligand comprising at least one basic group;
   wherein the ligand comprises at least one group capable of binding the metal species.
46. A salt comprising a cation of a polymer comprising basic ionisable groups and an anion of a ligand;
   wherein the basic ionisable groups of the polymer are N-containing groups, preferably amine groups;
   and wherein the ligand is a C₁-C₁₂ alkyl comprising: (i) at least one carboxyl group or sulfonic acid group, and (ii) at least one thiol, thioether, thioamide, dithiocarbamate, thionyl, amine, or a combination thereof, preferably wherein the ligand is a C₁-C₁₂ alkyl comprising: (i) at least one carboxyl group, and (ii) at least one thiol, thioether, thioamide, amine, or a combination thereof.
47. A salt comprising an anion of a polymer comprising acidic ionisable groups and a cation of a ligand; wherein the acidic ionisable groups of the polymer are carboxyl groups or sulfonic acid groups; and wherein the ligand is a C₁-C₁₂ alkyl comprising: (i) at least one N-containing group, and (ii) at least one thiol, thioether, thioamide, amine, or a combination thereof.
48. The use according to clause 45 or the salt according to clause 46 or 47, wherein the molar ratio of the monomer units of the polymer to the ligand is from about 1:4 to about 8:1.
49. The use according to clause 45 or clause 48, or the salt according to any one of clauses 46 to 48, wherein the salt further comprises a metal species, preferably wherein the metal species is bound to the at least one group of the ligand capable of binding a metal species.
50. A composition comprising the salt according to any one of clauses 46 to 49.
51. The composition according to clause 50, wherein the composition is an aqueous solution comprising said salt.
52. A product comprising (i) a complex comprising:
   (a) a cation of a polymer comprising basic ionisable groups and an anion of a ligand comprising at least one acidic group; or
      an anion of a polymer comprising acidic ionisable groups and a cation of a ligand comprising at least one basic group; and
   (b) a metal species; and
   (ii) a precipitant;
   wherein the ligand comprises at least one group capable of binding a metal species and the metal species is bound to said at least one group; and
   wherein the precipitant comprises at least one group that is bound to the metal species and/or the polymer and further comprises at least one hydrophobic moiety.
53. The product according to clause 52, wherein the complex of polymer, ligand, metal species, and precipitant, together form a polymer-ligand-metal species-precipitant aggregate.

What is claimed is:

1. A process for removing a metal species from a solution, wherein the solution comprises the metal species and a solvent, which process comprises treating the solution with a polymer comprising ionisable groups, and a ligand, to form a complex; and treating the solution with a precipitant; wherein:
the ionisable groups of the polymer are basic and the ligand comprises at least one acidic group, or wherein the ionisable groups of the polymer are acidic and the ligand comprises at least one basic group;
the ligand comprises at least one group that binds the metal species; and
the precipitant comprises at least one group that binds the metal species and/or the polymer, and at least one hydrophobic moiety.

2. The process of claim 1, wherein the ligand electrostatically binds the polymer.

3. The process of claim 1, wherein the complex comprises:
a positively charged species formed from the polymer and a negatively charged species formed from the ligand, or a negatively charged species formed from the polymer and a positively charged species formed from the ligand; and
the metal species.

4. The process according to claim 1, wherein the process comprises:
mixing the polymer with the ligand to form a salt; wherein the salt comprises a positively charged species formed from the polymer and a negatively charged species formed from the ligand, or a negatively charged species formed from the polymer and a positively charged species formed from the ligand;
or wherein the process comprises:
(i) mixing the polymer with the ligand to form a salt; wherein the salt comprises a positively charged species formed from the polymer and a negatively charged species formed from the ligand, or a negatively charged species formed from the polymer and a positively charged species formed from the ligand; and
(ii) treating the solution comprising the metal species and the solvent with the salt formed in step (i) to form the complex as defined in claim 1; and treating the solution with the precipitant.

5. The process according to claim 4, wherein the salt is in the liquid phase, optionally wherein said liquid phase salt is an aqueous salt solution.

6. The process according to claim 1, wherein treating with the precipitant causes the complex to precipitate from the solution.

7. The process according to claim 1, wherein the metal species is selected from noble metal species, optionally wherein the metal species is selected from platinum group metal species, copper species, gold species, silver species, or a combination thereof.

8. The process according to claim 1, wherein the metal species is a metallic ion, optionally wherein the metal species is a metallic cation.

9. The process according to claim 1, wherein the ionisable groups of the polymer are basic and the ligand comprises at least one acidic group, optionally wherein the ionisable groups of the polymer are N-containing groups.

10. The process according to claim 9, wherein the polymer comprises: polyethyleneimine, polyvinylamine, polyallylamine, chitosan, polylysine, polyarginine, or a combination thereof, and/or wherein the at least one acidic group of the ligand is selected from carbon-based acids, sulfur-based acids, phosphorus-based acids, or a combination thereof.

11. The process according to claim 9, wherein the at least one acidic group of the ligand is selected from a carboxyl group, a sulfonic acid group, a phosphoric acid group, a phosphinic acid group, and a phosphonic acid group.

12. The process according to claim 1, wherein the ionisable groups of the polymer are acidic and the ligand comprises at least one basic group.

13. The process according to claim 12, wherein the ionisable groups of the polymer are selected from carboxyl groups, sulfonic acid groups, phosphoric acid groups, phosphinic acid groups, phosphonic acid groups, or a combination thereof.

14. The process according to claim 12, wherein the polymer comprises monomeric units which are aliphatic or aromatic hydrocarbons, and wherein the ionisable groups are carboxyl groups or sulfonic acid groups.

15. The process according to claim 13, wherein the polymer comprises poly(meth)acrylic acid, polyaspartic acid, polyglutamic acid, alginic acid, polyvinylsulfonic acid, polyphosphoric acid, or a combination thereof, and wherein the at least one basic group of the ligand is a N-containing group.

16. The process according to claim 1, wherein the at least one group that binds the metal species comprises at least one sulfur atom, phosphorus atom, nitrogen atom, oxygen atom, or a combination thereof.

17. The process according to claim 16, wherein the at least one group that binds the metal species comprises at least one thiol, thioether, thioester, thioamide, dithiocarbamate, thionyl, phosphine, phosphite, phosphate, amine, imine, amide, N-heterocycle, alcohol, ether, ester, ketone, carboxylic acid, or a combination thereof.

18. The process according to claim 1, wherein the ligand comprises (i) a C₁-C₁₂ hydrocarbyl, and (ii) at least one amine group and at least one thioyl or phosphonate group; at least two amine groups; at least two carboxylic acids; or at least one carboxylic acid and at least one amine, thiol, thioether, thioamide, thioester, dithiocarbamate, thionyl or phosphonate group; or wherein the ligand comprises a C₁-C₁₀ heteroaryl, and at least one thiol, thioether, thioester, thioamide, dithiocarbamate, thionyl, amine, imine, amide, alcohol, ether, ester, ketone, carboxylic acid, or a combination thereof.

19. The process according to claim 18, wherein the ligand comprises (i) a C₁-C₁₂ alkyl and (ii) at least one amine group and at least one thioyl or phosphonate group; at least two amine groups; at least two carboxylic acids; or at least one carboxylic acid and at least one amine, thiol, thioether, thioamide, thioester, dithiocarbamate, thionyl or phosphonate group; or wherein the ligand comprises a N-heterocycle containing 1 to 5 carbon atoms, and at least one thiol, thioether, thioester, dithiocarbamate, thienyl, ester, ketone, carboxylic acid, or a combination thereof.

20. The process according to claim 1, wherein the precipitant is a surfactant or a polymer with ionisable groups, the ionisable groups being of opposite charge to the complex-forming polymer with ionisable groups defined in claim 1.

21. The process according to claim 20, wherein:
(i) the ionisable groups of the polymer are basic, and the precipitant is selected from an anionic surfactant, a cationic surfactant, a polymer with at least one acidic group, and mixtures thereof; or
(ii) the ionisable groups of the polymer are acidic, and the precipitant is selected from an anionic surfactant, a cationic surfactant, a polymer with at least one basic group, and mixtures thereof.

22. The process according to claim 1, wherein:
the metal species is selected from platinum group, gold and silver metal species;
the ionisable groups of the polymer are basic N-containing groups;
the ligand comprises a C₁-C₁₂ alkyl and: (i) at least one carboxyl group or sulfonic acid group, and (ii) at least one thiol, thioether, thioester, thioamide, phosphonate, dithiocarbamate, thionyl, amine, or a combination thereof; or the ligand comprises a N-heterocycle containing 1 to 5 carbon atoms, and at least one thiol, thioether, thioester, thioamide, dithiocarbamate, thionyl, alcohol, ether, ester, ketone, carboxylic acid, or a combination thereof; and
the precipitant is selected from an anionic surfactant, a cationic surfactant, and mixtures thereof.

23. The process according to claim 22, wherein the ligand has the formula: 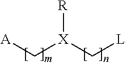
wherein n is 0 to 5; m is 1 to 5; L is a carboxyl group or an amine; A is selected from thiol, thioether, thioester, thioamide, dithiocarbamate, thionyl, phosphonate and amine; X is C or N; and R is selected from hydrogen, C₁₋₅ alkyl, thiol, thioether, thioester, thioamide, dithiocarbamate, thienyl, and amine, provided that when X is N, R is hydrogen or C₁₋₅ alkyl.

24. The process according to claim 1, wherein:
the metal species is a copper species;
the ionisable groups of the polymer are basic N-containing groups or acidic S-containing groups;
the ligand comprises a C₁-C₁₂ alkyl and: (i) at least one carboxyl group, sulfonic acid or phosphonate group, and (ii) at least one thiol, thioether, thioester, thioamide, dithiocarbamate, thionyl, amine, or a combination thereof; or the ligand comprises a N-heterocycle containing 1 to 5 carbon atoms, and at least one thiol, thioether, thioester, thioamide, dithiocarbamate, thionyl, or a combination thereof; and
the precipitant is selected from an anionic surfactant, a cationic surfactant, a polymer with ionisable groups, the ionisable groups being of opposite charge to the basic N-containing groups or acidic S-containing groups of the polymer with ionisable groups, and mixtures thereof.

25. The process according to claim 24, wherein the ligand has the formula: 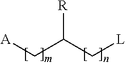
wherein n is 0 to 5; m is 1 to 5; L is a carboxyl group or an amine; A is selected from thiol, thioether, thioester, thioamide, dithiocarbamate, thionyl, and phosphonate; and R is selected from hydrogen, thiol, thioether, thioester, thioamide, dithiocarbamate, and thionyl.

26. A salt comprising:
a. a cation of a polymer comprising basic ionisable groups and an anion of a ligand; wherein the basic ionisable groups of the polymer are N-containing groups; and wherein the ligand comprises a C₁-C₁₂ alkyl and: (i) at least one carboxyl group, sulfonic acid or phosphonate group, and (ii) at least one thiol, thioether, thioester, thioamide, dithiocarbamate, thionyl, amine, or a combination thereof; or wherein the ligand comprises a N-heterocycle containing 1 to 5 carbon atoms, and at least one thiol, thioether, thioester, thioamide, dithiocarbamate, thionyl, alcohol, ether, ester, ketone, carboxylic acid, or a combination thereof; or
b. an anion of a polymer comprising acidic ionisable groups and a cation of a ligand; wherein the acidic ionisable groups of the polymer are carboxyl groups or sulfonic acid groups; and wherein the ligand comprises a C₁-C₁₂ alkyl and: (i) at least one N-containing group, and (ii) at least one thiol, thioether, thioester, thioamide, amine, phosphonic acid group, or a combination thereof; or wherein the ligand comprises a N-heterocycle containing 1 to 5 carbon atoms, and at least one thiol, thioether, thioester, thioamide, dithiocarbamate, thionyl, alcohol, ether, ester, ketone, carboxylic acid, or a combination thereof.

27. The salt according to claim 26, wherein the molar ratio of the monomer units of the polymer to the ligand is from about 1:4 to about 8:1.

28. The salt according to claim 26, wherein the salt further comprises a metal species, optionally wherein the metal species is bound to at least one group of the ligand.

29. A composition comprising the salt according to claim 26, optionally wherein the composition is an aqueous solution comprising said salt.

30. A product comprising:
a. a complex comprising:
i. a cation of a polymer comprising basic ionisable groups and an anion of a ligand comprising at least one acidic group; or an anion of a polymer comprising acidic ionisable groups and a cation of a ligand comprising at least one basic group; and
ii. a metal species; and
b. a precipitant;
wherein the ligand comprises at least one group capable of binding a metal species and the metal species is bound to said at least one group; and wherein the precipitant comprises at least one group that is bound to the metal species and/or the polymer and further comprises at least one hydrophobic moiety, optionally wherein the complex of polymer, ligand and metal species, and the precipitant, together form a polymer-ligand-metal species-precipitant aggregate.
